(19) United States
(12) Patent Application Publication
(10) Pub. No.: US 2026/0051099 A1
(43) Pub. Date: Feb. 19, 2026

(54) Systems and Methods for Deep Learning-Based MRI Reconstruction with Artificial Fourier Transform (AFT)

(71) Applicant: The Trustees of Columbia University in the City of New York, New York, NY (US)

(72) Inventors: Jia GUO, Fort Lee, NJ (US); Yanting Yang, New York, NY (US)

(73) Assignee: The Trustees of Columbia University in the City of New York, New York, NY (US)

(21) Appl. No.: 19/370,122

(22) Filed: Oct. 27, 2025

Related U.S. Application Data
(63) Continuation of application No. PCT/US2024/026766, filed on Apr. 29, 2024.
(60) Provisional application No. 63/462,698, filed on Apr. 28, 2023.
(60) Provisional application No. 63/639,283, filed on Apr. 26, 2024.

(51) Int. Cl. G06T 11/00; G06T 5/10; G06T 5/20; G06T 5/60; G06T 5/70

(52) U.S. Cl. CPC G06T 11/006; G06T 5/10; G06T 5/20; G06T 5/60; G06T 5/70; G06T 2207/10088; G06T 2207/20056; G06T 2207/20081; G06T 2207/20084; G06T 2211/441

(57) ABSTRACT

Disclosed are methods, systems, and other implementations, including a unified complex-valued deep learning framework (AFT-Net), which determines the k-space domain to image domain mapping for MRI reconstruction and allows incorporation of existing deep learning models. Embodiments include a computer-implemented method for reconstructing images that includes obtaining resonance (MR) k-space data resulting from a scan performed by an MRI scanner on tissue of a patient, with the MR k-space data including complex-valued data, and processing, by a complex-valued machine learning image reconstruction system, the complex-valued data of the MR k-space data to generate image data representing features of the MR k-space data. The processing may include performing data filtering operations, by one or more machine learning filter blocks implemented according to a CU-Net architecture realized using one or more convolutional neural networks (CNN) configured for complex data processing, on data that is based on the k-space data.

### CROSS-REFERENCE TO RELATED APPLICATIONS

This application is a continuation of International Application No. PCT/US2024/026766, filed Apr. 29, 2024, which claims priority to, and the benefit of, U.S. Provisional Application No. 63/639,283, entitled “Systems and Methods for Deep Learning-Based MRI Reconstruction with Artificial Fourier Transform (AFT)” and filed Apr. 26, 2024, and U.S. Provisional Application No. 63/462,698, entitled “Systems And Methods For Deep Learning-Based MRI Reconstruction With Artificial Fourier Transform (AFT)-NET” and filed Apr. 28, 2023, the contents of all of which are incorporated herein by reference in their entireties.

### BACKGROUND

Image reconstruction for Magnetic Resonance Imaging (MRI) is used across clinical workflow applications and lays the foundation for further image analysis, such as organ segmentation, lesion detection, lesion segmentation and classification. During image acquisition, the data matrix is commonly obtained in what is known as k-space, an array of numbers representing spatial frequencies in the MRI image before any preprocessing and Fourier transformation application. Due to random error and noise, conventional medical image reconstruction methods remain less parametric and lack generality.

Feature extraction engineering becomes problematic if the input or the target is not in the time domain, which means that the human experience is unreliable in such conditions. The domain conversion or data reconstruction from the sensor domain to the image domain is a critical task because it lays the foundation for all the following steps in the clinical workflow. How the raw data acquired from the imaging system sensors directly influences the overall image quality. The distortion caused by reconstruction cannot be restored from conventional imaging processing methods due to information loss inevitably caused during the domain conversion.

### SUMMARY

To solve the above-mentioned problem mentioned, a unified complex-valued image reconstruction approach for magnetic resonance images is proposed, which aims to remove any nondeep learning procedures in the workflow and incorporate data processing into deep learning frameworks. The framework described herein is referred to as the artificial Fourier transformation (AFT) which includes full functionality of a state-of-the-art Fourier transform. The framework is implemented with fully adjustable parameters that can be fine-tuned through further training. AFT is combined with deep complex networks to design an artificial Fourier transform network (AFT-Net) for MRI reconstruction and denoising. Given raw k-space data with a low signal-to-noise ratio (SNR), the AFT-Net framework can learn the mapping between two domains and remove noise while preserving useful structural information.

Deep learning methods based on artificial neural networks with multiple layers between input and output can automate the analytical model-building process and outperform traditional data processing techniques and shallow machine learning models. In recent years, many deep learning networks have been developed, such as recurrent neural networks (RNNs), convolutional neural networks (CNNs), transformers, generative adversarial networks (GANs), and diffusion models, which have revolutionized certain applications, including speech recognition, image classification, and medical image analysis.

With the accumulation of medical image data acquired from different sites, numerous open-access medical image datasets have become available for deep learning research, which allows the potential clinical uses of deep learning gradually to come into practice. Medical images from various imaging systems contain rich structural and functional information, which is vital to consider for disease diagnosis and treatment. Once these medical images are obtained, analysis tasks, including lesion detection, classification, and diagnosis, are usually performed by radiologists. However, due to the significant variation in pathology and the possible weariness of human experts, they cannot guarantee that the diagnosis to be consistent and unbiased.

Conventionally, numerical and machine learning methods require human experts to select task-related features and establish models that highly represent the mapping between the input domains to the target domains, and to prepare training data (defining the ground truths needed to train such machine learning models). With the improvement of computing hardware, it has become more feasible to use deep neural networks, which incorporate feature engineering extraction steps and simple preprocessing steps into the deep learning layers. With forward and backward propagation, the deep neural network can discover and determine the mapping of an input-target manifold through self-taught learning.

Important contributions of the framework described herein include:
Introduction of the AFT-Net framework, which is a novel data-driven unified MRI image reconstruction and denoising approach based on the artificial Fourier transformation (AFT) framework. AFT-Net disentangles real-world MRI k-space data with unpredictable noise into clean complex-valued images without coil compression.
Experimental results demonstrate that the AFT-net framework achieves superior denoising performance, as shown in FIG. 1A, which provides an image set 100 representations of conversion of k-space data into resultant reconstructed spatial domain images using various frameworks. The complex values network AFT-Net framework (that includes workflow architectures denoted as I, K, and KI, as will be discussed below in greater detail) performed better than conventional network. The proposed framework is also configured to perform accelerated imaging.
The proposed framework can be applied to different types of data. FIG. 1B is a schematic diagram 110 illustrating the generality of the AFT-Net framework. As will be discussed in greater detail below, the generality of AFT-Net is evaluated on the human normal-field MRI dataset (fastMRI), human low-field MRI dataset (M4Raw), mouse high-field MRI dataset, and human normal-field MRI dataset (Big GABA). The inputs of AFT-Net can be 2D MRI k-space data or 1D MRS FID data. The outputs are reconstructed MR images or spectra. Different structures/configurations of AFT-Net can be developed by appending front-end and/or back-end convolutional layers to the AFT block.
The proposed framework aims to get rid of any non-deep learning processes in the preprocessing workflow and incorporate data processing into deep learning frameworks. The framework includes trainable FC layers that approximate discrete Fourier transform (DFT) and complex-valued convolutional encoder-decoder networks to extract higher features in the k-space/image domain. Through this modular design, the proposed AFT-Net can be extended to any dimension (e.g., 1D MR spectroscopy data). The AFT-Net is used to accelerate/denoise MRI acquisition. In accelerated MRI reconstruction, the k-space data is under-sampled in the data acquisition direction (the phase-encoding direction). In denoised MRI reconstruction, a complex-valued Gaussian distribution is added to k-space data which approximates the thermal noise. The extended AFT-Net can also be applied to denoised MRS acquisition, where the free induction decay (FID) data is under-sampled by decreasing repetition numbers. Comprehensive experiments were conducted under various species, modalities, system field strength, acceleration ratios, and noise levels, to validate the performance of the proposed approach.
During experimentation and evaluation of the proposed framework, a pre-trained AFT-Net was applied on datasets with additional Gaussian noise in k-space and different contrast caused by gadolinium-based contrast agents (GBCAs) and retrained on the dataset with different contrast caused by different modalities. The results proved the robustness of our AFT-Net towards inputs with unseen variation.

Thus, in some variations, a computer-implemented method for reconstructing images is disclosed that includes obtaining resonance (MR) k-space data resulting from a scan performed by an MRI scanner on tissue of a patient, with the MR k-space data including complex-valued data, and processing, by a complex-valued machine learning image reconstruction system, the complex-valued data of the MR k-space data to generate image data representing features of the MR k-space data.

Embodiments of the method may include at least some of the features described in the present disclosure, including one or more of the following features.
processing by the complex-valued machine learning image reconstruction system may include estimating the image data with a machine learning inverse Fourier transform engine, implementing an inverse Fourier transform model, applied to input data based on the k-space data.

Estimating the image data may include estimating the image data with the machine learning inverse Fourier transform engine applied to the k-space data.

Processing by the complex-valued machine learning image reconstruction system further may include performing data filtering operations, by one or more machine learning filter blocks implemented according to a CU-Net architecture realized using one or more convolutional neural networks (CNN) configured for complex data processing, on data that is based on the k-space data.

Performing the data filtering operations may include performing, by a CU-Net filter block, from the one or more machine learning filter blocks, positioned upstream of the machine learning inverse Fourier transform engine, one or more of data segmentation processing and/or de-noising processing on the k-space data.

Performing the data filtering operations may include performing de-noising filtering operations, by a de-noising CU-Net filter block positioned downstream of the machine learning inverse Fourier transform engine, on the estimated image data produced by the machine learning inverse Fourier transform engine.

Performing the data filtering operations may include performing one or more of segmentation processing operations and/or de-noising processing on the k-space data by a first U-Net filter block, positioned upstream of the inverse Fourier transform engine, and performing one or more of segmenting operation and/or de-noising operations on the estimated image data, produced by the machine learning inverse Fourier transform engine in response to receiving the processed k-space data, by a second CU-Net filter block positioned downstream of the machine learning inverse Fourier transform engine.

The method may further include training the complex-valued machine learning image reconstruction system to generate estimated image data representing features of the MR k-space data based on samples of k-space data and corresponding image data representing ground truth for the complex-valued machine learning image reconstruction system.

The complex-valued machine learning image reconstruction system may be trained to produce high-quality images from low-quality MR k-space data.

Training the complex-valued machine learning image reconstruction system may include performing intermittent updated training for the complex-valued machine learning image reconstruction engine, including performing a transform on at least part of an MR k-space training dataset to produce a transform output, and evaluating a loss function to produce an error evaluation based at least in part on the estimated image data generated by the complex-values machine learning image reconstruction system and the transform output.

The method may further include adjusting parameters of the complex-valued machine learning image reconstruction engine based on the error evaluation produced by the loss function.

Performing the transform may include performing an inverse fast Fourier transform on at least part of the MR k-space training dataset.

The complex-valued machine learning image reconstruction engine may be further trained to produce denoised high-quality images.

In some variations, a system for reconstructing MRI images is provided that includes one or more computer-readable hardware storage devices to store and executable program code, and a processor-based device, in electrical communication with the one or more computer-readable hardware storage devices. The processor-based device is configured to obtain magnetic resonance (MR) k-space data resulting from a scan performed by an MRI scanner on tissue of a patient, with the MR k-space data including complex-valued data, and process, by a complex-valued machine learning image reconstruction system, the complex-valued data of the MR k-space data to generate image data representing features of the MR k-space data.

In some variations, a non-transitory computer readable media is provided that includes computer instructions executable on a processor-based device to obtain magnetic resonance (MR) k-space data resulting from a scan performed by an MRI scanner on tissue of a patient, with the MR k-space data including complex-valued data, and process, by a complex-valued machine learning image reconstruction system, the complex-valued data of the MR k-space data to generate image data representing features of the MR k-space data.

Embodiments of the system and the computer readable media may include at least some of the features described in the present disclosure, including at least some of the features described above in relation to the method.

Other features and advantages of the invention are apparent from the following description, and from the claims.

### BRIEF DESCRIPTION OF THE DRAWINGS

These and other aspects will now be described in detail with reference to the following drawings.

FIG. 1A includes a set of images comparing the conversion of k-space data into resultant reconstructed spatial domain images using various frameworks.

FIG. 1B is a schematic diagram illustrating the generality of an AFT-Net framework.

FIG. 2 is a schematic diagram depicting the reconstruction workflow implemented by the stages/modules of an example machine learning image reconstruction system (that includes a machine learning inverse Fourier transform engine).

FIG. 3 is a flow diagram representing operation of a machine learning inverse Fourier transform unit.

FIG. 4 is a block diagram of an example CU-Net architecture that can be used in conjunction with the AFT implementation to analyze and/or filter complex k-space data.

FIG. 5 includes block diagrams of a complex residual block and a complex attention gate, respectively, that are used in the implementation of the CU-NET architecture of FIG. 4.

FIG. 6 is a schematic diagram depicting the reconstruction workflow for several example denoising and reconstruction paths implemented using an AFT unit and one or more CU-Net blocks.

FIG. 7 provides a table listing performance metrics relating to the quantitative comparison of various reconstruction approaches.

FIG. 8 shows residual maps (computed by pixel-wise image subtraction) between the ground truth and the predicted reconstructed images produced by the image reconstruction engine.

FIG. 9 are boxplots with paired t-test in terms of PCC, SCC, PSNR, and SSIM.

FIG. 10 include a table summarizing the quantitative and qualitative comparisons of the performance of AUTOMAP and various AFT-Net paths with respect to reconstruction plus denoising tasks.

FIG. 11 includes results of the quantitative and qualitative comparisons of the performance of AUTOMAP and AFT-Net with respect to for reconstruction plus denoising tasks on various datasets.

FIG. 12 includes tables listing performance metrics for various models trained with a reduction factor R=2 and R=4.

FIG. 13 includes a qualitative visual comparison of AUTOMAP and AFT-Net for reconstruction plus accelerated imaging task.

FIG. 14 is a flowchart of an example computer-implemented procedure for reconstructing images.

FIGS. 15A-15B includes diagrams of different workflows used with the various additional experiments of Study 2 discussed in relation to FIGS. 16A-19B.

FIG. 16A-16G include graphs and images showing results for the human normal-field MRI experiments.

FIGS. 17A-17G include graphs and images showing results for the human low-field MRI experiments.

FIGS. 18A-18E include graphs and images showing results for the mouse high-field MRI experiments.

FIGS. 19A-19B include graphs for results of the human normal-field MRS experiments.

Like reference symbols in the various drawings indicate like elements.

### DESCRIPTION

The present disclosure is directed to a unified complex-valued deep learning framework—Artificial Fourier Transform Network (AFT-Net)—which determines the k-space domain to image domain mapping for MRI reconstruction, and allows incorporation of existing deep learning models. The framework aims to remove non-deep learning process from the workflow, while maintaining full functionality of a state-of-the-art Fourier transform. The proposed framework includes fully adjustable parameters that can be fine-tuned through further training. AFT combined with deep complex networks is utilized to design an artificial Fourier transform network (AFT-Net) for MRI reconstruction and denoising. Given raw k-space data (provided to the network as unseparated complex-valued data, i.e., without re-arranging the raw data into, for example, separate real and imaginary data sets) with a low signal-to-noise ratio (SNR), AFT-Net can learn the mapping between two domains and remove noise while preserving useful structural information.

More particularly, AFT-Net disentangles MRI k-space data with unpredictable noise to clean complex-valued images without coil compression. Experimental results demonstrated that AFT-Net achieves superior denoising performance.

Deep complex networks are architectures for deep learning based on complex-valued operations and representations. The complex-valued deep neural network leverages the richer representational capacity of complex numbers and facilitates noise-robust memory retrieval mechanisms. Learning in the frequency domain also causes the neural network to implement learning-based frequency selection, which is not achievable with conventional building blocks and techniques.

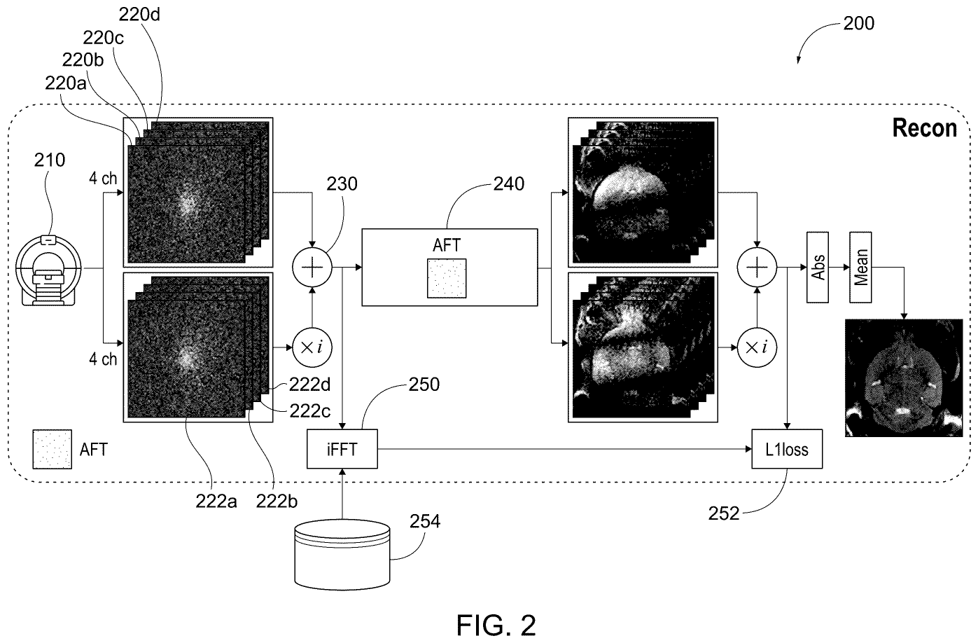

With reference to FIG. 2, a schematic diagram depicting the reconstruction workflow implemented by the stages/modules of an example AFT-Net network 200 is shown. As illustrated, an MRI system 210 performs an MRI procedure on a person to collect k-space data arranged, for example, in matrices 220a-d and 222a-d (e.g., stored in a memory storage device coupled to a computing device used to process the k-space data according to the AFT-Net network approach). Each channel of data corresponds, in the example of FIG. 2, to a separate coil used to perform the magnetic resonance imaging procedure. While the complex-valued k-space data is collected from four channels (e.g., an MRI scanner with 4 coils, such as the 4-coil Bruker 9.4T scanner), fewer or more channels (corresponding to fewer or more coils) can be used.

The k-space data stored in the matrices 220a-d and 222a-d is combined at summing module 230, and provided to an AFT machine learning system 240 configured to produce, in response to receipt of the input complex data, predicted image representation data corresponding to the image data that would have been produced through optimized inverse frequency domain conversion procedures (such as the inverse fast Fourier Transform, or iFFT). That is, the AFT machine learning system 240 is adapted to generate image reconstruction, through a training process in which adjustable parameters of the machine learning system have been optimized to produce output matching the ground truth associated with the input k-space data (e.g., image data that is optionally free of artefacts or noise).

In some embodiments, the AFT machine learning system is implemented based on a complex-valued neural network architecture. The definition of the conventional real-valued neural network can be extended to the complex domain. Denote a complex operator as W=Wᵣₑₐₗ+iW_{imag} where Wᵣₑₐₗ and W_{imag} are real-valued operators. The input complex vector can the represented as x=xᵣₑₐₗ+ix_{imag}. The output of complex operator W acting on x is derived by multiplication as follows:

$$y = W * x = ( {W}_{r e a l} * {x}_{r e a l} - {W}_{i m a g} * {x}_{i m a g} ) + i ( {W}_{i m a g} * {x}_{r e a l} + {W}_{r e a l} * {x}_{i m a g} ) , \qquad Eq . ( 1 )$$

Since the linear operator and convolution operation are distributive, then:

$$ℂ Linear ( z ) = {Linear}_{1} ( ℛ ( z ) ) - {Linear}_{2} ( 𝒥 ( z ) ) + {Linear}_{2} ( ℛ ( z ) ) + {Linear}_{1} ( 𝒥 ( z ) ) , \qquad Eq . ( 2 )$$

$$And$$

$$ℂ Conv ( z ) = C o n {v}_{1} ( ℛ ( z ) ) - C o n {v}_{2} ( 𝒥 ( z ) ) + i ( C o n {v}_{2} ℛ ( z ) ) + C o n {v}_{1} ( 𝒥 ( z ) ) , \qquad Eq . ( 3 )$$

where z∈C, and the subscripts 1 and 2 represent real and imaginary values, respectively.

The complex version of the ReLU activation function used in the present disclosure study is simply applying separate ReLU on both the real and the imaginary part of the input as follows:

$$ℂ R e L U ( z ) = R e LU ( ℛ ( z ) ) + i ReLU ( 𝒥 ( z ) ) , \qquad Eq . ( 4 )$$

The above expression satisfies Cauchy-Riemann equations when both the real and the imaginary parts have the same sign or θ_{z}∈[0, ½π]∪[π, 3/2 π].

Normalization is a common technique widely used in deep learning to accelerate training and reduce statistical covariance shift. This is also mirrored in the complex-valued neural network, where it is desirable to ensure that both the real and the imaginary parts have equal variance. Extending the normalization equation to matrix notation provides:

$$\tilde{z} = {V}^{- \frac{1}{2}} ( z - E ( z ) ) , \qquad Eq . ( 5 )$$

where x-E(x) is simply zero centers the real and imaginary parts separately, providing:

$$z - E ( z ) = [ \begin{matrix}ℜ ( z ) - Mean ( ℜ ( z ) ) \\ 𝔍 ( z ) - Mean ( 𝔍 ( z ) )\end{matrix} ] , \qquad Eq . ( 6 )$$

and V is the covariance matrix, namely:

$$V = [ \begin{matrix}{V}_{rr} & {V}_{ri} \\ {V}_{ir} & {V}_{ii}\end{matrix} ] + ϵ I = [ \begin{matrix}COV ( ℜ ( z ) , ℜ ( z ) ) , & COV ( ℜ ( z ) , 𝔍 ( z ) ) \\ OV ( 𝔍 ( z ) , ℜ ( z ) & COV ( 𝔍 ( z ) , 𝔍 ( z ) )\end{matrix} ] + ϵ I . \qquad Eq . ( 7 )$$

V is a 2×2 matrix, and the existence of the inverse square root is guaranteed by the addition of ϵI (Tikhonov regularization). Therefore, the solution of the inverse square root can be expressed analytically as:

$$V = [ \begin{matrix}A & B \\ C & D\end{matrix} ] ⇒ {V}^{- \frac{1}{2}} = [ \begin{matrix}D + s / d & - B / d \\ - C / d & ( A + s ) / d\end{matrix} ] , \qquad Eq . ( 8 )$$

where s=\sqrt{AD−BC}, t=\sqrt{A+D+2s, and d=st}. The complex normalization is defined as:

$$Norm ( z ) = γ \tilde{z} + β = [ \begin{matrix}{γ}_{rr} & {γ}_{rr} \\ {γ}_{ri} & {γ}_{ii}\end{matrix} \tilde{z} ] + [ \begin{matrix}ℜ ( β ) \\ 𝔍 ( β )\end{matrix} ] . \qquad Eq . ( 9 )$$

Considering the limitation of GPU RAM and large memory consumption of complex-valued networks, the complex group normalization can be used, under the proposed framework, to avoid possible inaccurate batch statistics estimation caused by a small batch size.

As noted, the present approach implements an inverse Fast Fourier Transform using a machine learning system trained to convert complex-valued inputs into output approximating the laborious and voluminous iFFT computations that would otherwise need to be performed. A 2D discrete Fourier transform (DFT) is a linear operation and can be represented by two successive 1D DFTs as:

$${ℱ}_{x , y} \{ f ( x , y ) \} = {ℱ}_{x} \{ {ℱ}_{y} \{ f ( x , y ) \} \} = {ℱ}_{y} \{ {ℱ}_{x} \{ f ( x , y ) \} \} , \qquad Eq . ( 10 )$$

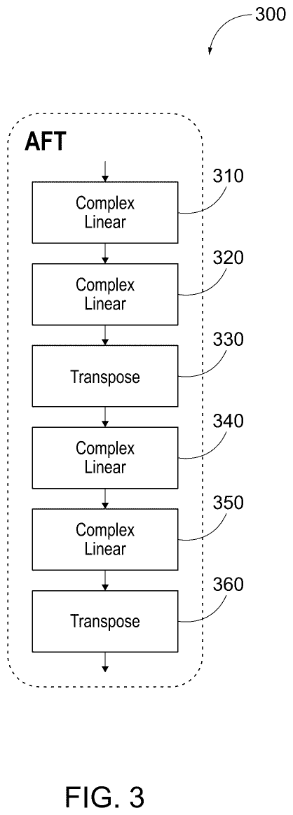

Each dimension of 2D DFT can be modeled as a single-hidden-layer neural network with a linear activation function. This approach can similarly be implemented with complex-valued neural networks and proposed AFT with two repeated blocks, as depicted in FIG. 3, showing a flow diagram 300 representing operation of the AFT unit 240 of the machine learning reconstructions system that includes two complex linear layers (blocks 310 and 320, and later 340 and 350) followed by a transpose operation (block 330, following blocks 310 and 320, and transpose block 360 following blocks 340 and 350). Each block includes two complex linear layers followed by a transpose operation. From the definition of the discrete Fourier transform of a sequence of N complex numbers which can be represented in the real and imaginary parts, the following expression is derived:

$${Z}_{k} = {\sum }_{n = 0}^{N - 1} {z}_{n} [ cos ( \frac{2 π}{N} kn ) - i sin ( \frac{2 π}{N} kn ) ] , \qquad Eq . ( 11 )$$

The above expression can be re-written as

$${Z}_{k} = {W}_{real} z + {iW}_{imag} z , \qquad Eq . ( 12 )$$

where Wᵣₑₐₗ and W_{imag} are the real and the imaginary coefficients. Using matrix notation to represent real and imaginary parts of the DFT operation, yields:

$$[ \begin{matrix}ℜ ( {Z}_{k} ) \\ 𝔍 ( {Z}_{k} )\end{matrix} ] = [ \begin{matrix}{W}_{real} & - {W}_{imag} \\ {W}_{imag} & {W}_{real}\end{matrix} ] [ \begin{matrix}ℜ ( z ) \\ 𝔍 ( z )\end{matrix} ] , \qquad Eq . ( 13 )$$

Thus, a multi-layer complex-valued neural network with linear activation function can represent 1D DFT with appropriate weights. AFT_{N} can be used to denote the complex-valued Fourier transform deep learning block on the input vector with N elements. The Fourier transform of the input data with dimension H×W can therefore be represented as:

$$Z = {AFT}_{H} {( {AFT}_{W} {( z )}^{T} )}^{T} . \qquad Eq . ( 14 )$$

Turning back to FIG. 2, the system 200 additionally includes an inverse Fast Fourier Transform (iFFT) unit 250 and a L1-Loss computation unit 252 (to optimize the adjustable parameters of the AFT so that they yield strong approximations, in response to the k-space input values, as what would be produced through the iFFT procedure) that together are used in the training process of the AFT machine learning system 240. Particularly, during the training stage (and optionally intermittently during runtime when the performance of the machine learning is updated using runtime data), input k-space data produced, for example, by the MRI sensor (or alternatively, k-space data acquired and stored from data repositories, such as the repository 254, storing k-space data and/or corresponding image data) is transformed by the iFFT unit 250 to produce image data (i.e., produced through traditional domain transformation processes). The same k-space input data is provided to the machine learning reconstruction system 240 to produce resultant predicted data. During training, parameter optimization of the parameters of the AFT unit of the system 240 is performed by seeking to minimize the error between image data produced by the iFFT unit 250 and image data produced by the machine learning system 240. Parameter optimization can be performed, as noted, using the L1-Loss computation unit (other loss functions can also be used), which, upon completion of the optimization process (e.g., after optimizing for some pre-determined sets of k-space data) transfers the computed optimized parameters to the AFT unit 240 to update the parameters of the AFT unit of the machine learning reconstruction (the parameters may represent weights of links connecting neurons of a neural network implementation of the AFT unit). It is noted that the loss function and the iFFT unit 250 can also be used to evaluate the performance of the AFT unit 240 (i.e., to assess the quality of the reconstructed image data).

In the context of image reconstruction and processing, the impact of the loss function is important if the final results are to be evaluated by human observers. One common and safe choice is [symbol] 2 loss which works under the assumption of white Gaussian noise. However, the impact of noise may depend on the local region, structure, and contrast. Other error metrics like [symbol] 1 loss prove to be more robust to noise and achieves higher image quality. The [symbol] 1 loss can be represented simply as:

$${ℒ}^{{ℓ}_{1}} = \frac{1}{N} \vert {\sum }_{p ∈ P} ⌈ x ( p ) - y ( p ) ⌉ \vert , \qquad Eq . ( 15 )$$

and the derivatives are:

$$\frac{\partial {ℒ}^{{ℓ}_{1}} ( P )}{\partial x ( p )} = sign ( x ( p ) - y ( p ) ) . \qquad Eq . ( 16 )$$

Compared with [symbol] 2 loss, [symbol] 1 loss weighs more errors if [symbol] p∈(−1, 1) and does not over penalize more significant errors, which makes [symbol] 1 loss easier to reach the better minimum. Therefore, [symbol] 1 loss is used for both reconstruction and denoising tasks but in a slightly different manner. For the reconstruction task, the AFT should be preferred to preserve the magnitude and phase information fully, so both the real and the imaginary parts are considered. The reconstruction loss can be represented as:

$${ℒ}^{recon} = {αℒ}^{{ℓ}_{1}} ( ℜ ( x ) , ℜ ( y ) ) + ( 1 - α ) {ℒ}^{{ℓ}_{1}} ( 𝔍 ( x ) , 𝔍 ( y ) ) , \qquad Eq . ( 17 )$$

where α can be chosen to α=0.5 to assign equal weights to both real and imaginary parts. For the reconstruction plus denoising task, the amplitude images are the final targets, so it is desirable to minimize the distance between predicted images and target images as follows:

$${ℒ}^{denoise} = {ℒ}^{{ℓ}_{1}} ( \vert x \vert , \vert y \vert ) , \qquad Eq . ( 18 )$$

where |·| represents complex modulus.

In some embodiments, an architecture that includes only the AFT unit of the machine learning image reconstruction 240 to reconstruct images from the k-space data (with the AFT unit of FIG. 2 producing approximated image data predicted through a trained machine learning system), the approximation generated by the AFT unit can be configured to also perform denoising operation. This can be performed, for example, by providing k-space data that has been corrupted (artificially, or as a result of actual measurements), and providing to the training path ground truth data that includes corresponding image data that is free of noisy artifacts (i.e., providing as input to the AFT corrupted images, and adjusting the parameters of the machine learning unit to cause estimated image data produced by the AFT unit to converge to, preferably, the noise free ground truth image samples provided).

Alternatively, in some embodiments, the system architecture depicted in FIG. 2 can be modified to implement different approaches to perform denoising operations on the k-space data and/or the reconstructed image data (i.e., reconstructed through processing performed by the machine learning AFT unit on k-space data to produce predicted image data). For example, for the reconstruction plus denoising task, the AFT, discussed in relation to FIG. 2, can be combined with an entirely complex U-Net unit configured to extracts higher features in the k-space and/or image domain that forces the network to represent sparsely in those domains. Briefly, a conventional U-Net framework is one based on convolutional neural networks, with a U-shaped architecture that includes multiple encoder blocks on the architecture's contracting path, and multiple decoder blocks defining an expansion path. Each encoder block typically includes sequential convolutional blocks followed by a ReLU operation, and a max pooling operation (a type of down-sampling operation). The decoder path includes a series of up-convolutional and concatenation operation performed on high-resolution featured extracted from the contracting path. The U-Net architecture has been shown to be effective for performing image segmentation, particularly for biomedical image data.

The complex U-Net (referred to as CU-Net) leverages k-space MR signals while training a U-Net with Attention and Residual components (as opposed to using processed spatial (real) data, typically seen with MRI deep learning applications). Despite the rapid expansion of deep learning applications in biomedicine, most deep learning architectures are designed for the real space. Studies have shown that complex numbers bring various advantages, including better generalization and less noisy retrieval from associative memory. As MR signals are intrinsically of complex representation, this demands the incorporation of the complex space into neural network structures. The CU-Net framework implements a fully-complex U-Net model with Residual and Attention components (Residual Attention U-Net). It has been hypothesized that a network receiving complex k-space MRI data will have more information in a given instance in comparison to one receiving processed magnitude-only input. Thus, U-Net encoding in the complex domain can potentially lead to improved feature extraction and data encoding necessary for image translation.

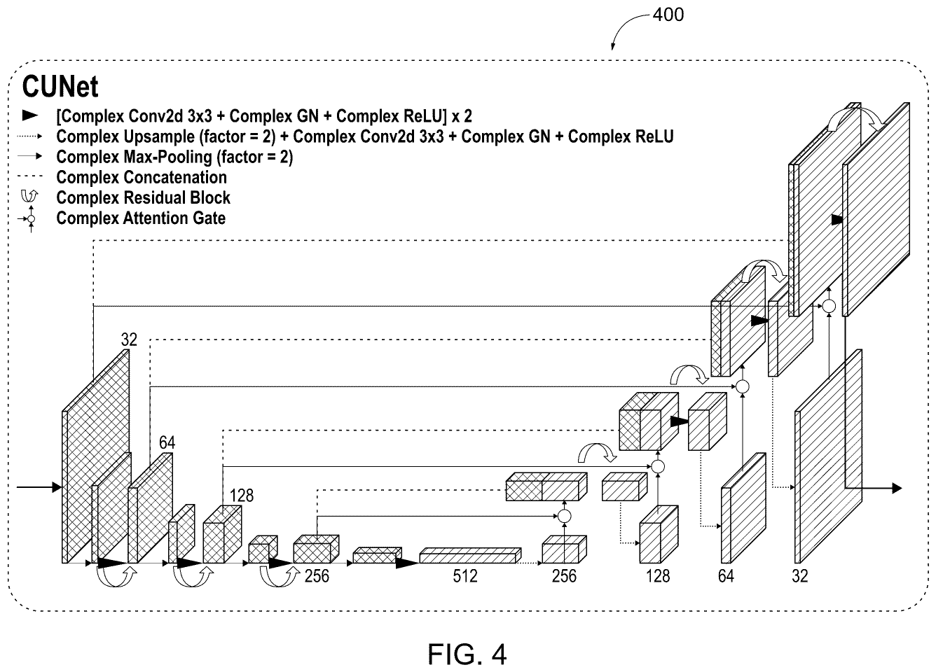

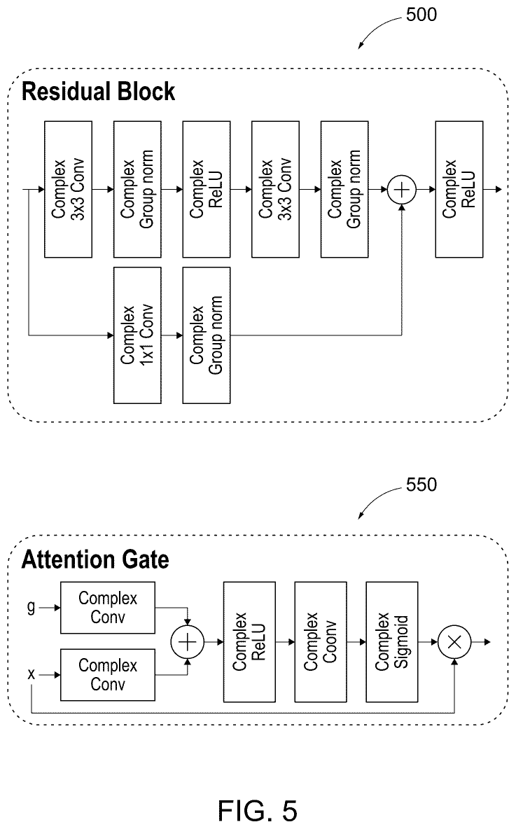

FIG. 4 is a block diagram of an example CU-Net architecture 400 that can be used in conjunction with the AFT implementation to analyze complex k-space data. The CU-Net architecture 400 is implemented as a complex version of residual attention U-Net with all the real-valued components replaced by complex-valued components. As illustrated in FIG. 4, the architecture 400 can include multiple (e.g., 4) encoding layers and multiple (e.g., 4) decoding layers. In some embodiments, the encoders are configured to decrease the spatial dimension by 2, and increase channel dimension by a factor of 2 as the data propagates through the encoding layers. The reverse operations are performed along the decoding layers. A similar structure is used for networks with 3, 5, and 6 layers. FIG. 5 includes block diagrams 500 and 550 of a complex residual block and a complex attention gate, respectively that are used in the implementation of the CU-NET architecture 400 of FIG. 4. Other components of the CU-Net architecture, such as the convolutional layers, ReLU layers, transposed convolution operators, sigmoid operators, etc., can be similarly implemented to handle complex data.

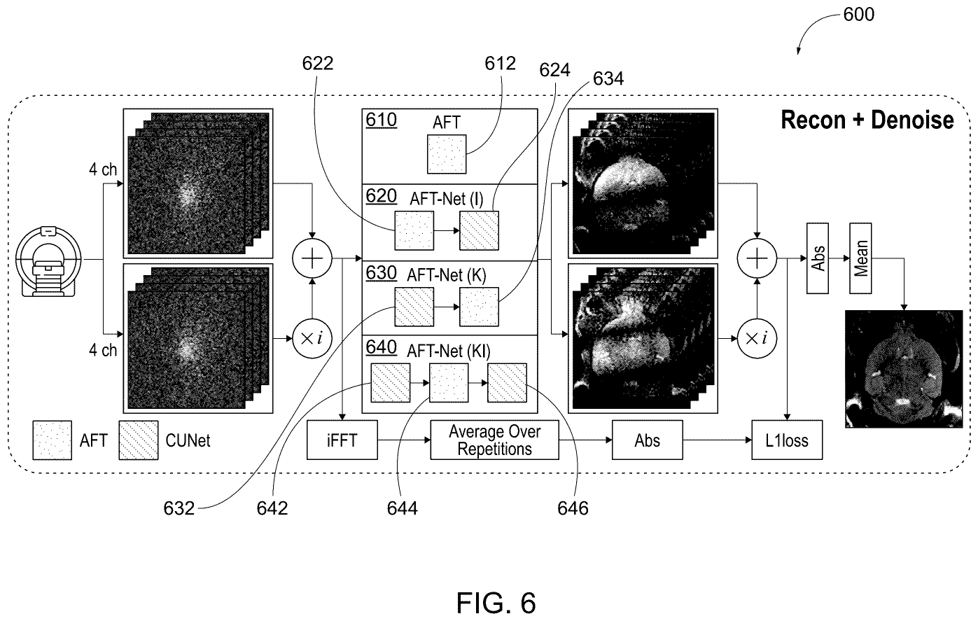

FIG. 6 includes a schematic diagram 600 depicting the reconstruction workflow for several example denoising and reconstruction paths implemented using an AFT unit and one or more CU-Net blocks. A first example path 610 includes only an AFT unit 612 (which may be similar in its implementation to the AFT machine learning system 240 of FIG. 2) that may be trained to see if, without a non-linear activation function, the AFT unit 612 can remove noise and enhance quality. A second possible path 620, referred to as AFT-NET (I), includes an AFT unit 622 (similar to the AFT machine learning system 240) followed by the CUNet block 624 that extracts image domain features obtained through the AFT-based transformation performed on the k-space data. The second workflow path 620 is trained to simulate a typical deep learning workflow where conventional numerical methods are used to preprocess the image, and CNNs are utilized to map the input domain to the target domain. A third example workflow path 630, referred to as AFT-Net (K) includes a CU-Net block 632 that is implemented to operate directly on the k-space domain. The CU-Net block 632 may be configured to extract important features from the k-space data. The resultant output of the CU-Net block 632 is then transformed to the image domain via an AFT unit 634.

Finally, a fourth example path 640, referred to as AFT-Net (KI) includes a CUNet-AFT-CUNet structure in which a first CUNet implementation 642 extracts k-space domain features, followed by an AFT unit 644 that transforms the output data of the CUNet implementation 642 into the image domain, followed by a second CUNet implementation 646 that extracts image domain features.

In various examples, the target is derived from the inverse fast Fourier transform on the input data. The AFT does not compress the coil channel so that the input and output shapes/sizes are the same. The network performance is evaluated within magnitude images obtained by Fourier application and coil compression. For the reconstruction plus denoising task, the AFT is combined with a complex U-Net, which extracts higher features in the k-space and/or image domain and forces the network to represent sparsely in those domains.

During the testing and evaluation of the implementations of the proposed framework, multiple network architectures/configurations were evaluated to verify the effectiveness of both AFT and CUNet in different domains. The architectures include AFT, AFT-Net (I), AFT-Net (K), and AFT-Net (KI), respectively, as shown in FIG. 6.

In one embodiment, an AFT-only network was first trained to see if, without a non-linear activation function, the AFT could remove noise and enhance quality. In another embodiment, a network with the AFT followed by a CUNet was trained to simulate a typical deep learning workflow where conventional numerical methods were used to preprocess the image, and convolutional neural networks (CNNs) were utilized to map the input domain to the target domain. The network with CUNet was also evaluated when first implemented directly on the k-space domain. Given that each position in k-space contains the information of the whole image, CNNs implemented in k-space can leverage the complete information of all spaces, even if they have a fixed field of view. In another embodiment, a CUNet-AFT-CUNet structure was evaluated with the first CUNet extracting k-space domain features and the second CUNet extracting image domain features.

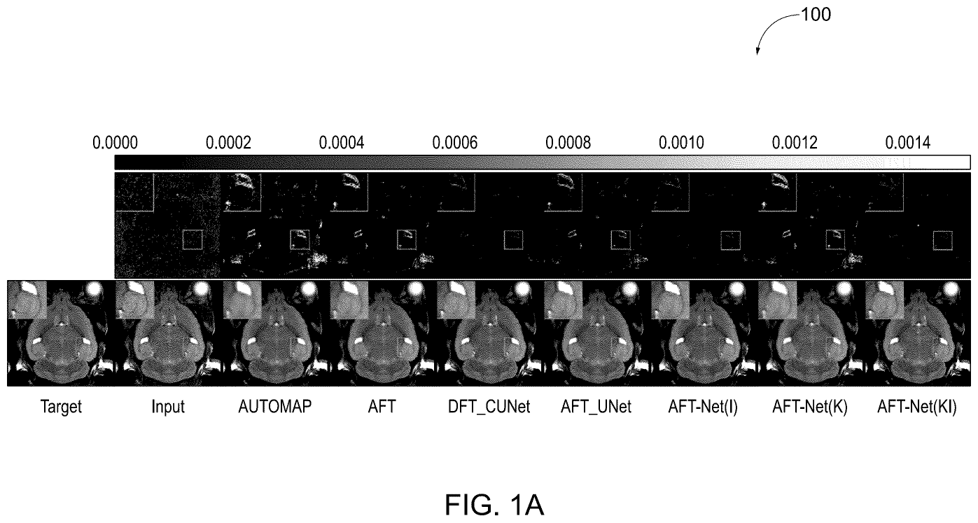

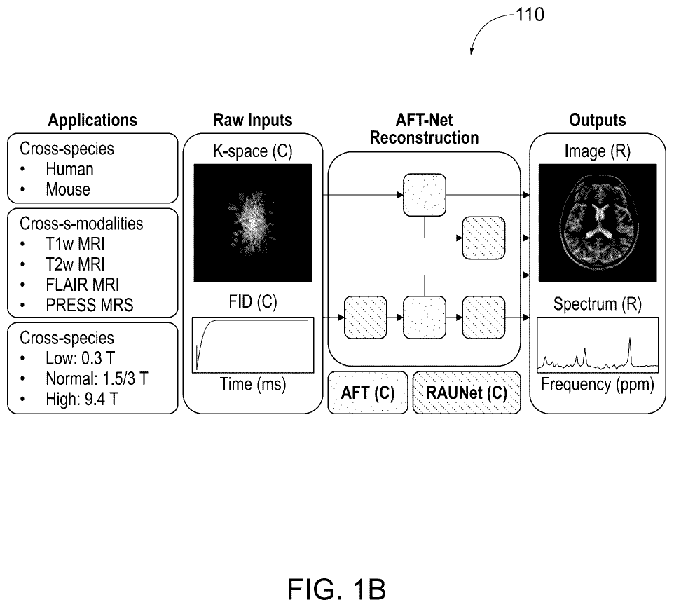

As noted above in relation to FIG. 1, evaluation and testing of the AFT-Net-based workflow architectures (e.g., the workflow architectures 610, 620, 630, and 640 depicted in FIG. 6) has shown that the AFT-Net-based architecture achieves better performance result (e.g., in terms of the image quality produced from MRI k-space data) than conventional approaches. Further details regarding the evaluation and testing conducted of the different AFT-Net-based workflow architectures, and of the obtained results, follows.

All the various image reconstruction approaches were tested, trained, and/or evaluated (Study 1 experiments) on real-world datasets with different contrasts and modalities, including T1-weighted (T1W) MRI, and T2-weighted (T2w) MRI before and after applying GBCAs (gadolinium-based contrast agents). Scans were acquired through a 4-coil Bruker 9.4T scanner, and the k-space data were extracted from raw data using the Bruker-supplied MATLAB package PVtools without coil compression. The size of each slice was 201×402 with resolution 0.075 mm×0.075 mm. The T2w MRI dataset contained 243 subjects that each was scanned for 4 repetitions before the injection of GBCAs. The dataset was split into the training, validation, and testing sets, with 195, 24, and 24 subjects, respectively. All approaches (workflow paths/architectures) were first trained on the T2w MRI dataset for reconstruction and reconstruction plus denoising tasks. The pre-trained AUTOMAP (a neural network for low-resolution single-coil MRI with 60% subsampling) and AFT-Net denoising models were then applied to MRI scans with more artifacts and different contrast on ten (10) subjects randomly selected from the testing set. The image intensity in MR magnitude images were shown to be governed by a Rician distribution under the assumption that the noise in k-space had to have a Gaussian distribution with zero mean. Thus, the pretrained approached were first applied to the T2w MRI dataset with simulated additional Gaussian noise added to the real and the imaginary parts separately.

These approaches were then evaluated on the T2w MRI dataset with GBCAs. The various approaches were also re-trained, using pre-trained denoising models, on the T1w dataset with 18 subjects not contained in the T2w dataset. The training, validation, and testing sets were split into 14, 2, and 2 subjects. Finally, AUTOMAP and AFT-Net were trained for reconstruction and accelerated imaging on the T2w dataset with under-sampling in the phase-encoding direction.

The training process was performed as follows. A batch size of 4 was constructed, and raw k-space data was fed without data preprocessing. The initial learning rate was set to 10⁻³, where an ADAM optimizer was used to update the trainable parameters. A Pearson correlation coefficient (PCC), Spearman's rank correlation coefficient (SCC), peak signal-to-noise ratio (PSNR), and structural similarity (SSIM) were adopted as evaluation metrics for quantitative comparison. A learning rate scheduler was used based on the PSNR in the validation set. When the metric has stopped improving, the learning rate was reduced by a factor of \sqrt{10}. Patience was set to 2 and the lower bound of the learning rate was set to 10⁻⁶. The training would stop early once learning started stagnating and the learning rate reached the lower bound. All experiments were done using PyTorch 1.11.0 and a Quadro RTX 6000 GPU.

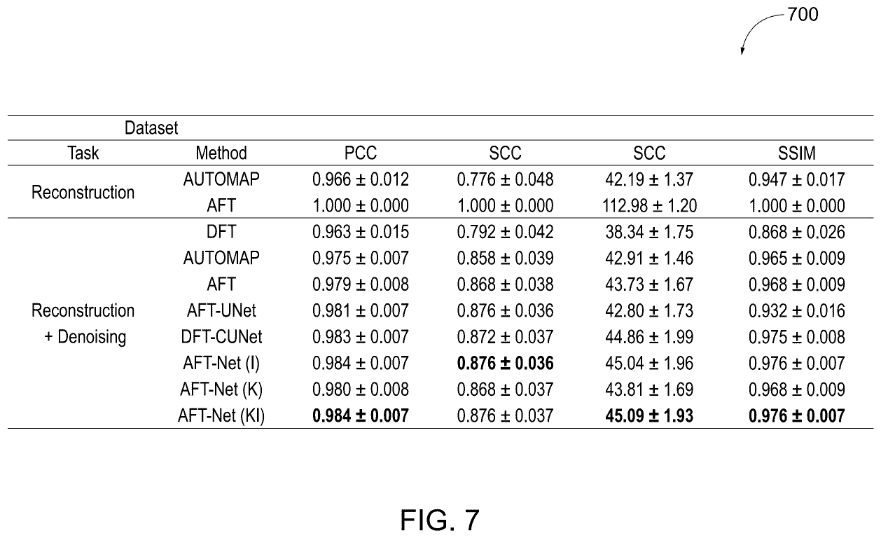

In training for the reconstruction task, [symbol] ^{recon} (as defined in Eq. (17), above) was used so that both magnitude and phase information were preserved. FIG. 7 provides a table 700 with performance metrics relating to the quantitative comparison of approaches trained on reconstruction and reconstruction plus denoising tasks. All methods were trained on the real-world T2w dataset. In table 700 real-valued networks were compared with complex-valued networks, AFT-based networks were compared with DFT-based networks, and AFT-Net was compared with other approaches in terms of PCC, SCC, PSNR, and SSIM. The performance metrics shown in table 700 indicate that the AFT performs the same (but with fewer computations) as a state-of-the-art discrete Fourier transform. The advantage of using AFT instead of DFT is that AFT has fully adjustable parameters. AFT can be naturally incorporated into any deep learning framework without other modification of and can be further improved after retraining. AFT also allows the feasibility of switching between trainable and static blocks simply by freezing the parameters.

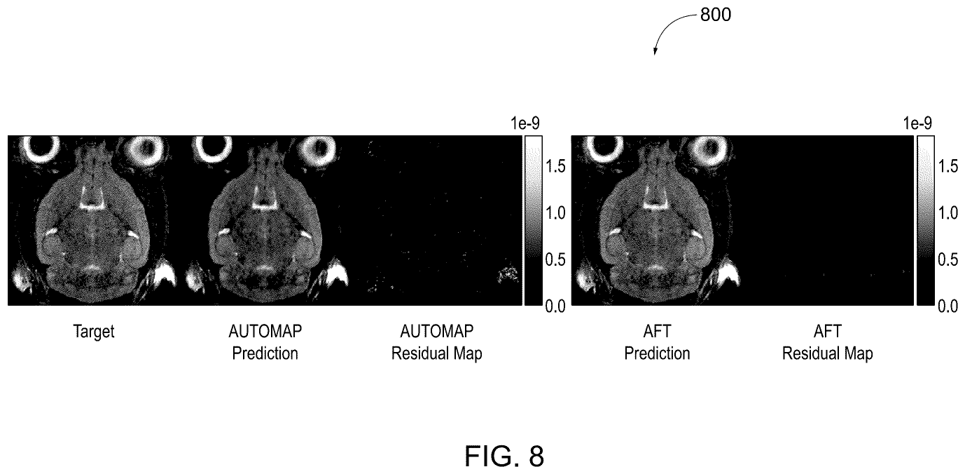

Ground truth obtained from DFT are identical to the AFT prediction, which human observers cannot distinguish. Instead of showing the ground truth, the residual map (computed by pixel-wise image subtraction) between the ground truth and the prediction generated by the reconstruction engine being trained, is presented in FIG. 8, which includes images providing qualitative comparison of AUTOMAP and AFT for a reconstruction task on the T2w dataset. It can be seen that no structural information is presented in the residual map of AFT, while AUTOMAP over-smoothes the image. The error is mainly caused by precision loss during floating-point calculation in matrix multiplication. The maximum error exists in the eyes and neck region, where motion artifacts are commonly present due to respiration and eye movement, which is inevitable for in-vivo MRI scans.

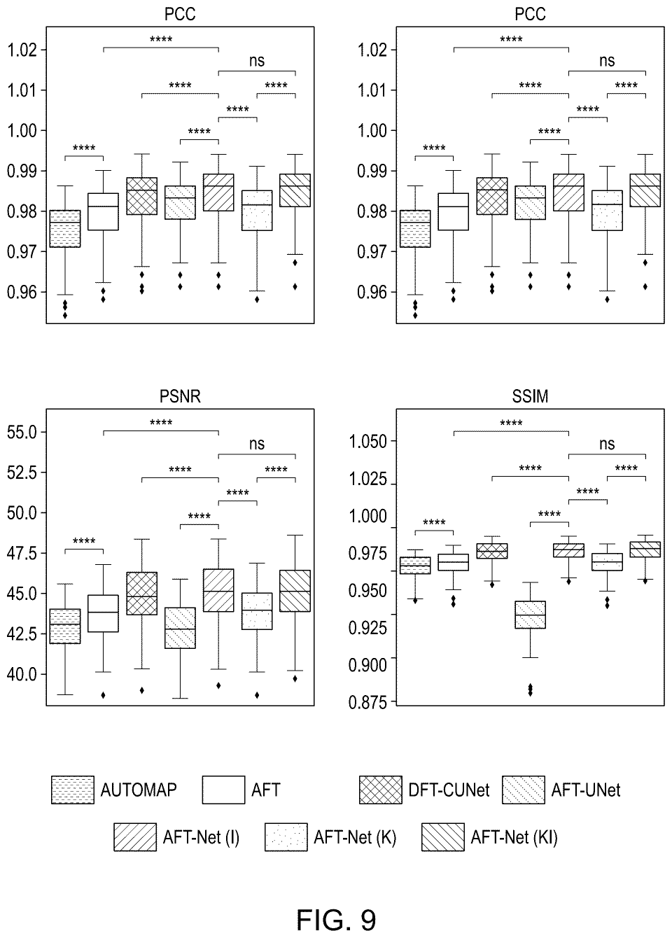

In training for the reconstruction plus denoising task, AFT-Net was compared with DFT-based networks, real-valued neural networks, and other. The quantitative results are provided in table 700 of FIG. 7, and the boxplots with paired t-test in terms of PCC, SCC, PSNR, and SSIM are shown in FIG. 9. An AFT-only network can outperform AUTOMAP even without CNNs (convolutional neural networks). Compared with AFT, CNNs in an AFT-Net (I) path (such as the path 620 depicted in FIG. 6) can extract higher features and introduce non-linearity, enhancing overall performance. Comparing DFT-CUNet with AFT-Net (I), a learnable AFT block can remove noise artifacts in k-space before feeding into CNNs while keeping the anatomy information needed. Comparing AFT-UNet with AFT-Net (I), the complex-valued network leverages the correlation between the real and imaginary parts and significantly improves the structural similarity. The real-valued network performs worse in terms of PSNR and SSIM due to failed elimination of some abnormal values in the image domain.

Different combinations of AFT with CUNet were also evaluated in this study. The AFT-Net (K) achieves the lowest performance, indicating that implementing CUNet in image domain (i.e., after performing the conversion, through AFT, from the k-space domain to the image domain) contributes to the enhanced performance. Compared with AFT-Net (I), statistical tests (illustrated in the boxplots of FIG. 9) indicate that AFT-Net (KI) (illustrated as the path 640 in FIG. 6) achieves better performance in terms of PSNR and SSIM, showing that the addition of CUNet in k-space can slightly improve the performance.

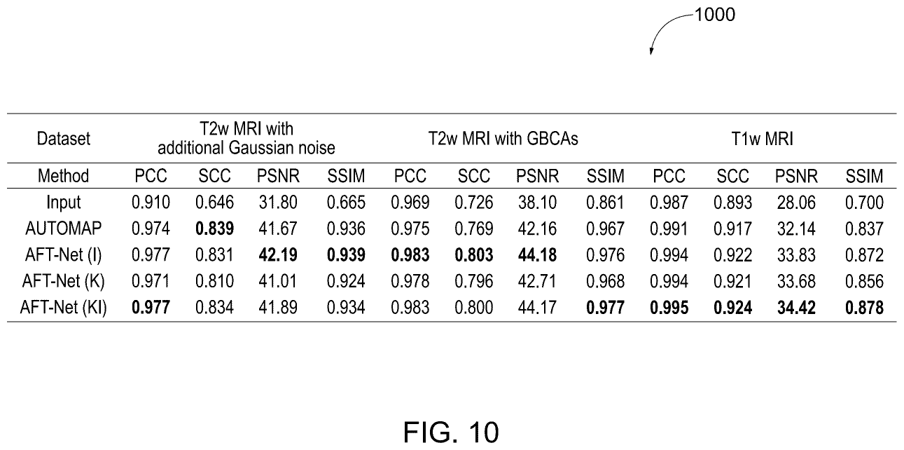

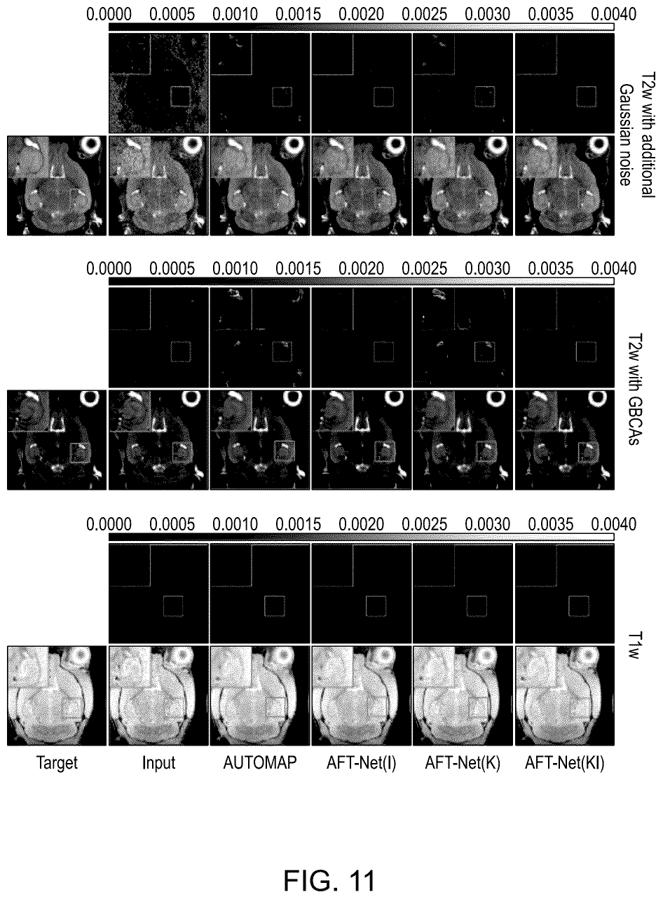

The pre-trained denoising methods were evaluated on the T2w MRI dataset with simulated Gaussian noise, and on the T2w MRI dataset with GBCAs to test the generality and robustness of the AFT-Net. The denoising approaches were then retrained based on pre-trained models on the smaller-scale T1w MRI dataset to verify the transfer learning ability of AFT-Net for insufficient training data. The quantitative and qualitative comparisons are presented in Table 1000 of FIG. 10, which includes a quantitative comparison of AUTOMAP and the AFT-Net on the reconstruction plus denoising task under three conditions: a) applying pre-trained denoising methods to the T2w MRI dataset with additional Gaussian noise, b) applying pre-trained denoising methods to the T2w MRI dataset with GBCAs, and c) retraining methods on the T1w MRI dataset. Results of the quantitative and qualitative comparisons are also provided in FIG. 11, which includes images representing qualitative comparison of AUTOMAP and AFT-Net for reconstruction plus denoising task on the T2w MRI dataset with simulated Gaussian noise, the T2w MRI dataset with GBCAs, and the T1w MRI dataset.

For evaluation on the T2w MRI dataset with additional Gaussian noise, the quantitative results in Table 1000 show that AFT-Net (I) can significantly improve the PSNR by 10 dB, proving that AFT-Net is more robust to noise and artifacts. The visual comparison in FIG. 11 also shows that the AFT-Net framework can keep the structure of vessels intact while removing noise. For evaluation on the T2w MRI dataset with GBCAs, AFT-Net is more robust to the contrast difference presented in the image domain and shows an overall improvement compared with AUTOMAP. The visual comparison in FIG. 11 shows that AFT-Net can preserve small structures and contrast differences. For retraining on the T1w MRI dataset that the models have never seen before, performance metrics in Table 1000 show that AFT-Net can be smoothly applied to medical image reconstruction and denoising with other modalities using transfer learning. The success of transfer learning with AFT-Net uncovers the wide application in potential use in research and clinical practice.

Next, reconstruction with accelerated imaging was studied and evaluated. Here, AUTOMAP and AFT-Net were retrained for the reconstruction plus accelerated imaging task on the T2w MRI dataset. The reduction factor R was defined as the ratio of k-space data required for a fully sampled image to the amount collected in an accelerated acquisition. The input k-space data were under-sampled in the phase-encoding direction by setting the whole line to zero (if lines in k-space were zeroed with a one-line interval, the k-space data would then be under-sampled by factor R=2).

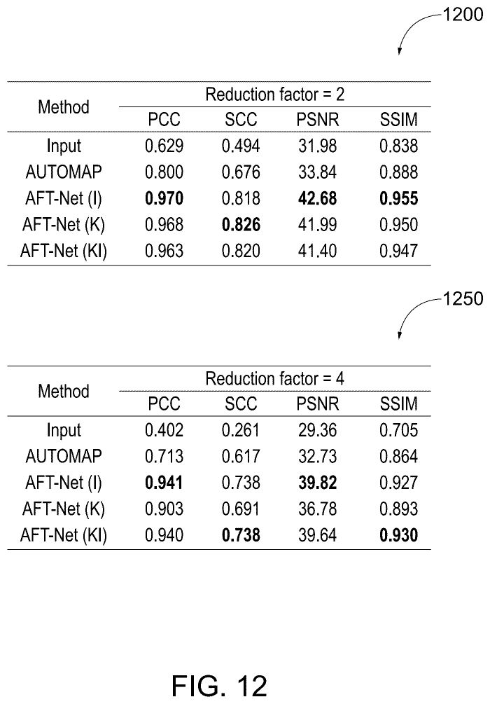

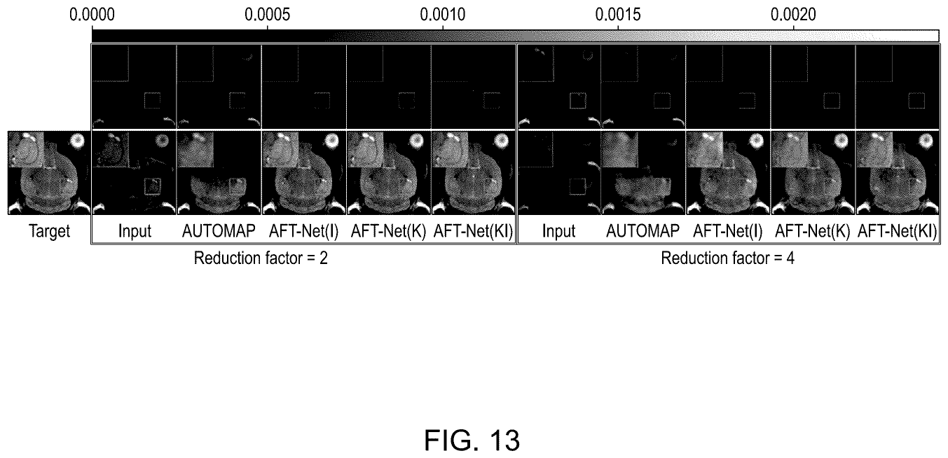

The performance metrics for models trained with R=2 and R=4 are shown in Table 1200 and Table 1250 of FIG. 12, respectively. A qualitative visual comparison of AUTOMAP and AFT-Net for reconstruction plus accelerated imaging task on T1w MRI dataset is provided in FIG. 13. Although AFT-Net is not designed for this task, it clearly shows its potential to accelerate the acquisition by a factor of 2, while AUTOMAP fails under all conditions. Under extreme conditions, when a minimal scan time is needed, the AFT-Net shows the ability to reconstruct the image with a reduction factor R=4 and less image quality loss.

In conclusion, the proposed framework described herein is directed to AFT, a novel artificial Fourier transform framework that is based on a machine learning model to determine the mapping between k-space and image domain, while having the ability to be fine-tune/optimize the framework with further training. The flexibility of AFT allows it to be easily incorporated into any existing deep learning network as learnable or static blocks.

AFT can be utilized to realize AFT-Net, which implements complex-valued U-Net to extract higher features in k-space and/or image domain. AFT allows combining reconstruction and denoising tasks into a unified network that simultaneously enhances the image quality by removing artifacts directly from the k-space and image domain.

The proposed approaches were evaluated on datasets with additional artifacts, different contrast, and different modalities. AFT-Net achieved competitive results compared with other approaches and proved to be more robust to noise and contrast differences. An extensive study on transfer learning demonstrated that this approach also applies to other modalities. A study on accelerated imaging showed the strength and superiority of AFT-Net over other approaches.

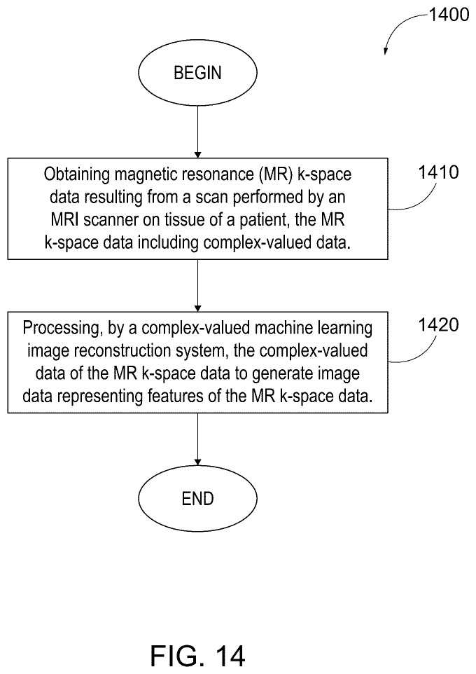

Next, with reference to FIG. 14, a flowchart of an example computer-implemented procedure 1400 for reconstructing images is shown. The procedure 1400 includes obtaining 1410 magnetic resonance (MR) k-space data resulting from a scan performed by an MRI scanner on tissue of a patient, the MR k-space data including complex-valued data. The k-space data can be obtained directly from an MRI scanner, and be arranged into local storage in the form of data matrices, where each coil of the MRI scanner produces real and imaginary data that is stored (in some embodiments) into separate matrices. Alternatively, the k-space data may be received from remote storage (e.g., in situations involving retrieval of samples of training data to train the machine learning image reconstruction system described herein). The procedure 1420 further includes processing 1420, by a complex-valued machine learning image reconstruction system, the complex-valued data of the MR k-space data to generate image data representing features of the MR k-space data.

In some embodiments, processing by the complex-valued machine learning image reconstruction system can include estimating the image data with a machine learning inverse Fourier transform engine, implementing an inverse Fourier transform model, applied to input data based on the k-space data. Thus, a machine learning system, such as the system represented by the block 240 of FIG. 2, produces estimates of an image reconstructed in response to input k-data. This estimation typically involves, in runtime, fewer computation than the more laborious processing required to reconstruct an image through conventional inverse Fourier transform (or inverse fast Fourier transform). Additionally, the training of the machine learning system can be such that the system is trained to remove noise or artefacts from, for example, the input k-space data to thus produce high quality image data from low-quality (e.g., noisy) k-space data. In various examples, estimating the image data may include estimating the image data with the machine learning inverse Fourier transform engine applied to the k-space data. That is, in such example embodiments, the machine learning inverse Fourier transform engine operates directly on the k-space data obtained without intermediate filter processing performed prior to the machine learning inverse Fourier transform engine performing the reconstruction operation.

Processing by the complex-valued machine learning image reconstruction system can further include performing data filtering operations, by one or more machine learning filter blocks implemented according to a CU-Net architecture realized using one or more convolutional neural networks (CNN) configured for complex data processing, on data that is based on the k-space data. Further details regarding the CU-Net architecture filter blocks are provided above in relation to FIGS. 4 and 5.

The machine learning system 240 of FIG. 2 can include filtering blocks before (upstream) and/or after (downstream) the machine learning inverse Fourier transform engine (marked in FIGS. 2 and 6 as the AFT unit). Thus, in various embodiments, performing the data filtering operations can include performing, by a CU-Net filter block, from the one or more machine learning filter blocks, positioned upstream of the machine learning inverse Fourier transform engine, one or more of data segmentation processing and/or de-noising processing on the k-space data. An example of this processing configuration (or pipeline) is provided in the processing path 630 of FIG. 6, which includes a CU-Net block 632 that performs some filtering processing on the k-space data, followed by an AFT unit 634. In various embodiments, performing the data filtering operations can include performing de-noising filtering operations, by a de-noising CU-Net filter block (such as the block 624 of the processing path 620 of FIG. 6) positioned downstream of the machine learning inverse Fourier transform engine (the AFT unit 622 of the path 620), on the estimated image data produced by the machine learning inverse Fourier transform engine.

In some embodiments, performing the data filtering operations may include performing one or more of segmentation processing operations and/or de-noising processing on the k-space data by a first U-Net filter block, positioned upstream of the inverse Fourier transform engine, and performing one or more of segmentation operation and/or de-noising operations on the estimated image data, produced by the machine learning inverse Fourier transform engine in response to receiving the processed k-space data, by a second CU-Net filter block positioned downstream of the machine learning inverse Fourier transform engine. Thus, in these embodiments (which are illustrate as the processing path 640 corresponding to the AFT-Net (KI) configuration), the AFT unit (performing machine learning estimation of the reconstructed image), two CU-Net blocks are used: one upstream of the AFT unit, and one downstream the AFT unit). The first CU-Net filter block performs pre-transformation filtering on the k-space data, while the second CU-Net filter block performs post image transformation filtering on the estimated reconstructed image data produced by the AFT unit (e.g., the unit 644 of the processing path 640).

In various examples, the procedure 1400 can further include training the complex-valued machine learning image reconstruction system to generate estimated image data representing features of the MR k-space data based on samples of k-space data and corresponding image data representing ground truth for the complex-valued machine learning image reconstruction system. As noted, the complex-valued machine learning image reconstruction system can be trained to produce high-quality images from low-quality MR k-space data. Training the complex-valued machine learning image reconstruction system can include performing intermittent updated training for the complex-valued machine learning image reconstruction engine (e.g., after the engine had become operational through the initial training cycle), including performing a transform (e.g., using a conventional inverse Fast Fourier Transform using the iFFT unit 250 of FIG. 2) on at least part of an MR k-space training dataset to produce a transform output, and evaluating a loss function (such as one implemented by the L1Loss unit 252) to produce an error evaluation based at least in part on the estimated image data generated by the complex-values machine learning image reconstruction system and the transform output.

In some examples, the procedure can further include further adjusting parameters of the complex-valued machine learning image reconstruction engine based on the error evaluation produced by the loss function. Performing the transform can include performing an inverse fast Fourier transform on at least part of the MR k-space training dataset.

The proposed framework described herein was tested on additional data sets (referred to herein as Study 2). The experimental results and various modifications made to evaluate the performance of network using different setups are discussed below.

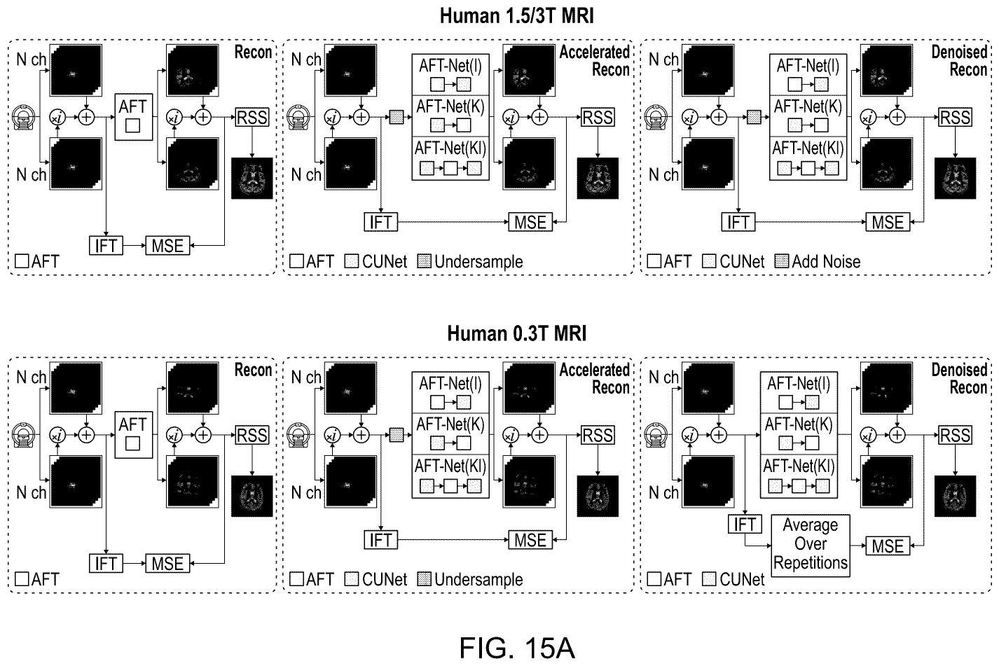

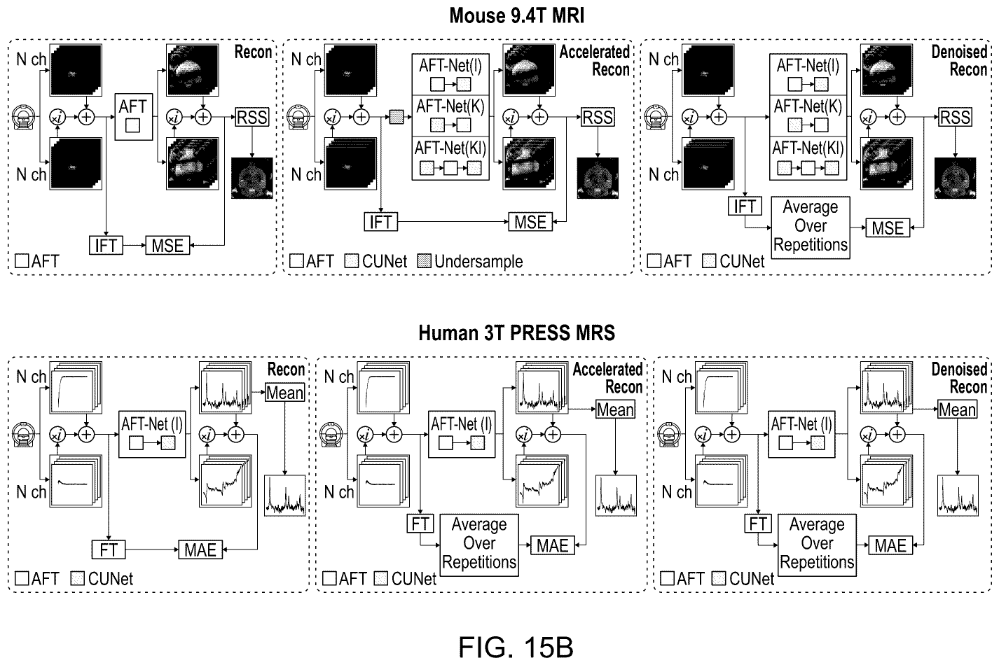

FIG. 15 includes diagrams of different workflows used with the various additional experiments that were conducted. For the data sets used for the additional experiments, a batch size of 1 was constructed and the network was optimized using the ADAM optimizer. The initial learning rate was set to 10⁻³, and a learning rate scheduler based on the SSIM was used in the validation set. When the metric had stopped improving, the learning rate is reduced by a factor of \sqrt{10}. The patience was set to a value of 2 and the lower bound of the learning rate was set to a value of 10⁻⁶. The training stopped early once learning stagnates and the learning rate reached the lower bound. All additional experiments discussed below were done using PyTorch 1.11.0 and a Quadro RTX 6000 GPU. For this set of experiments, the loss function used was an l2-based loss function which works under the assumption of white Gaussian noise. For training AFT for MRI reconstruction, the loss value was determined in the frequency domain as:

$${ℒ}^{recon} = {ℒ}^{{ℓ}_{2}} ( ℜ ( x ) , ℜ ( y ) ) + {ℒ}^{{ℓ}_{2}} ( 𝔍 ( x ) , 𝔍 ( y ) ) .$$

With the above loss function both real and imaginary outputs are optimized to match the conventional Fourier transformation. For training AFT-Net for accelerated MRI reconstruction, only the error of magnitude images needs to be minimized. Therefore, the loss value for accelerated MRI reconstruction is determined in the image domain after coil combination. The root-sum-of-squares (RSS) approach was applied to complex-valued output from the model to generate to optimal, unbiased estimate of magnitude image which is used for loss calculation.

Three brain MRI datasets and one brain MRS dataset were used for the additional experiments, namely: a complex-valued normal-field human brain MRI dataset from the fastMRI dataset, a complex-valued low-field human brain MRI dataset, a complex-valued high-field mouse brain dataset obtained from the Small Animal Imaging Lab, Zuckerman Institute, Columbia University), and a complex-valued human brain MRS dataset from the Big GABA dataset. The proposed workflows (illustrated in FIG. 15) were trained on these datasets separately.

The normal-field human brain MRI dataset contained fully sampled brain MRIs obtained on 3 and 1.5 Tesla magnets. A 4-channels axial T1-weighted and T2-weighted scans were selected from the raw fastMRI dataset. A total number of 993 scans were used with 794, 99, and 100 each for the training, validation, and test set. All the scans were first normalized to the max intensity value of one and cropped to 640×320 matrix size.

The low-field human brain MRI dataset contained fully sampled brain MRIs obtained on 0.3 Tesla magnets. A 4-channels axial T1-weighted, T2-weighted, and FLAIR scans were selected from the raw M4Raw dataset. A total number of 1264 scans were used with 1024, 122, and 118 each for the training, validation, and test set. All the scans were first normalized to the max intensity value of one and cropped to 256×256 matrix size.

The high-field mouse brain MRI dataset contained fully sampled brain MRIs obtained on 9.4 Tesla magnets using the Bruker Biospec 94/30 scanner and Para Vision 6.0.1. Each subject was scanned for 4 repetitions with a 4-channel CryoProbe. A total number of 960 scans were acquired from 240 subjects with 192, 24, and 24 each for the training, validation, and test set. All the scans were first normalized to the max intensity value of one and cropped to 416×224 matrix size.

The human brain MRS dataset contained GABA-edited MEGA-PRESS data obtained on 3T Philips scanners from different sites. Each subject was scanned for 320 averages (160 ON and 160 OFF repetitions). The data points acquired by each repetition was 2048. A total number of 101 scans were selected from the Big GABA dataset with 80, 10, and 11 each for the training, validation, and test set. All the scans were first normalized to the max spectra magnitude value of one.

During the accelerated MRI reconstruction, all the k-space data was undersampled from the fully sampled k-space by applying a mask in the phase-encoding direction. The acceleration rate (or acceleration factor) was used to denote the level of scan time reduced for the undersampled k-space data, which is defined as the ratio of the amount of k-space data required for a fully sampled image to the amount collected in an undersampled k-space data. The sampling ratio, SR, was also used to denote the information retained in the undersampled k-space data, which is defined as the inverse of the acceleration rate. An equi-spaced mask with approximate acceleration matching is used to undersample the k-space data. The fraction of low-frequency columns to be retained for acceleration rates 2×, 4×, 8×, and 16× are 16%, 8%, 4%, and 2% respectively.

During the denoised MRI reconstruction, complex-valued Gaussian noise was added to the k-space data with different levels. For the human normal-field MRI dataset, the standard deviation (or scale) was chosen to be 0.005, 0.01, and 0.02. For the human low-field MRI dataset, the scale was chosen to be 4.8. For the mouse high-field MRI dataset, the noisy scans could be chosen to be a single repetition or manually added Gaussian noise with a scale of 0.4.

For the Study 2 experiments, three metrics were adopted for the quantitative evaluation of the image quality compared with the ground truth: structural similarity (SSIM), peak signal-to-noise ratio (PSNR), and normalized root mean squared error (NRMSE). For the quality measurement of the 1D spectra, another three metrics were used: Pearson correlation coefficient (PCC), Spearman's rank correlation coefficient (SCC), and goodness-fitting coefficient (GFC). The GFC is introduced to evaluate the goodness of the mathematical reconstruction with a value ranging from 0 to 1, where 1 indicates a perfect reconstruction. If ŷᵢ is the predicted value of the i-th sample and yᵢ is the corresponding true value, then the GFC estimated over nₛₐₘₚₗₑₛ is defined as:

$$GFC ( y , \hat{y} ) = \frac{\vert {\sum }_{i = 0}^{{n}_{samples - 1}} {y}_{i} {\hat{y}}_{i} \vert}{{\vert {\sum }_{i = 0}^{{n}_{samples - 1}} {y}_{i}^{2} \vert}^{1 / 2} {\vert {\sum }_{i = 0}^{{n}_{samples - 1}} {\hat{y}}_{i}^{2} \vert}^{1 / 2}}$$

For the Study 2 experiments, different structures of involving AFT and NET processes discussed above (e.g., AFT, AFT-Net (I), AFT-Net (K), and AFT-Net (KI)) were compared for various MRI datasets with different field strengths, different species, and different modalities to verify the stability and generality of the AFT-Net. In addition, the effectiveness of the front-end/back-end convolutional networks was also evaluated. To validate the robustness of AFT-Net to k-space artifacts, these proposed AFT-Net structures were compared on the image reconstruction, accelerated reconstruction, and denoised reconstruction. Furthermore, the extended AFT-Net was compared with numerical methods using 1-dimensional MRS FID data on the denoised reconstruction.

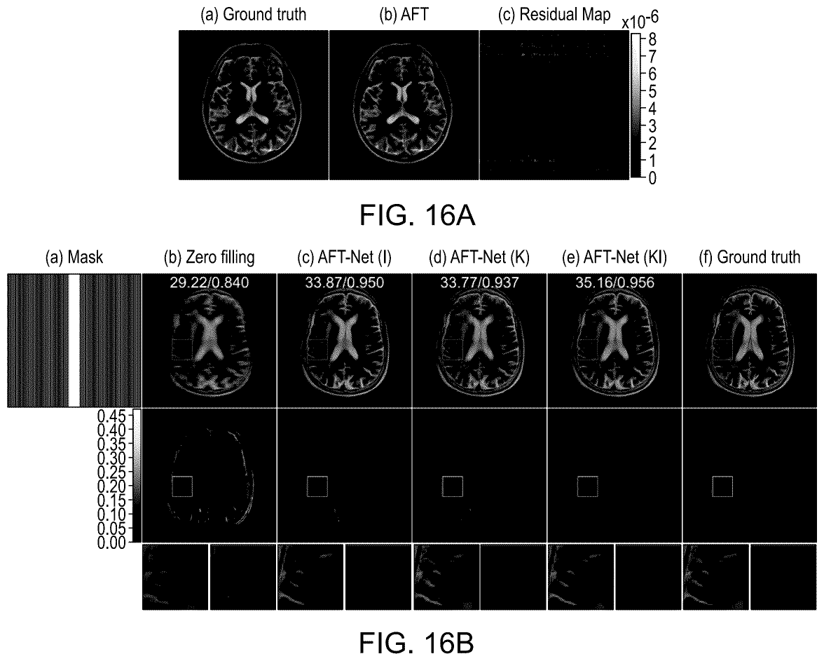

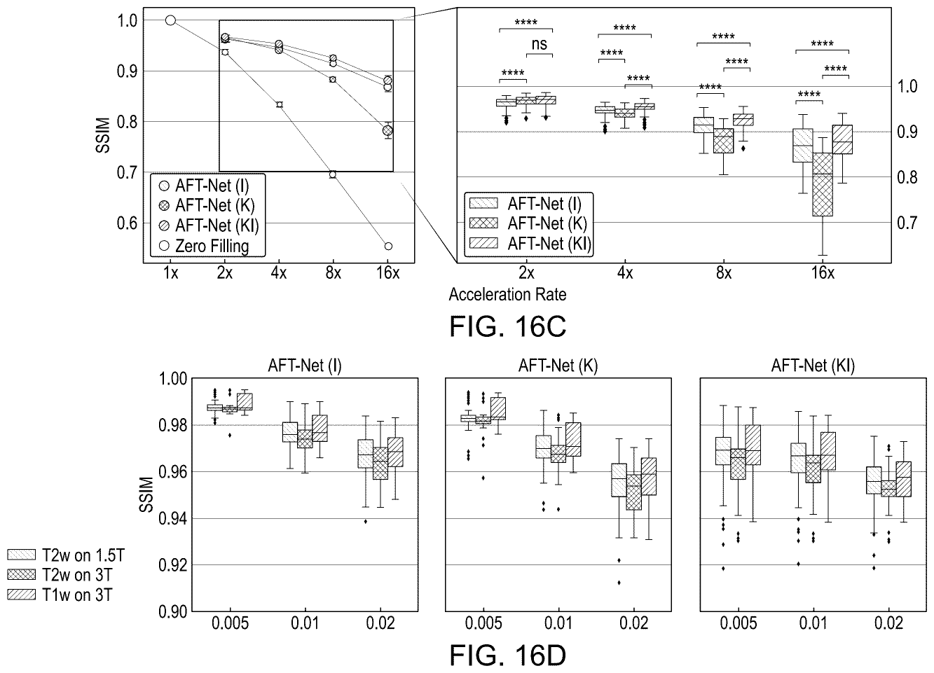

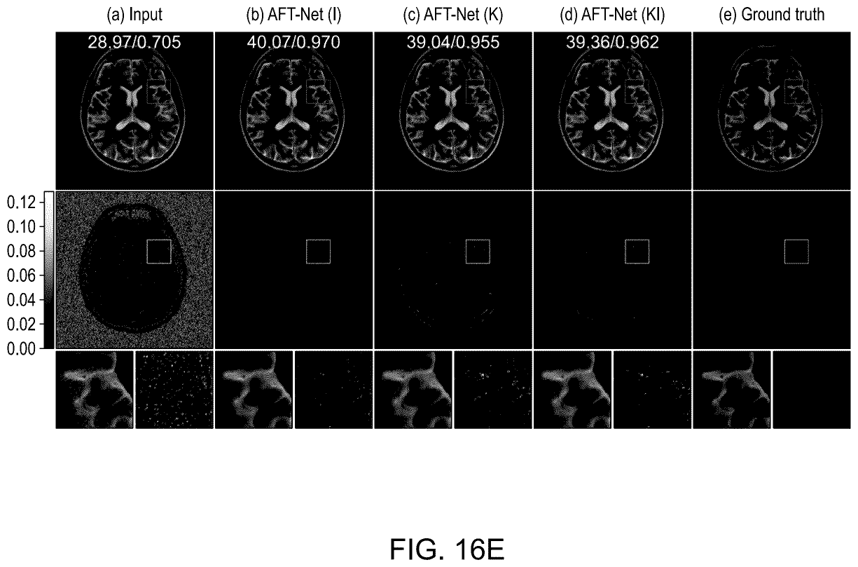

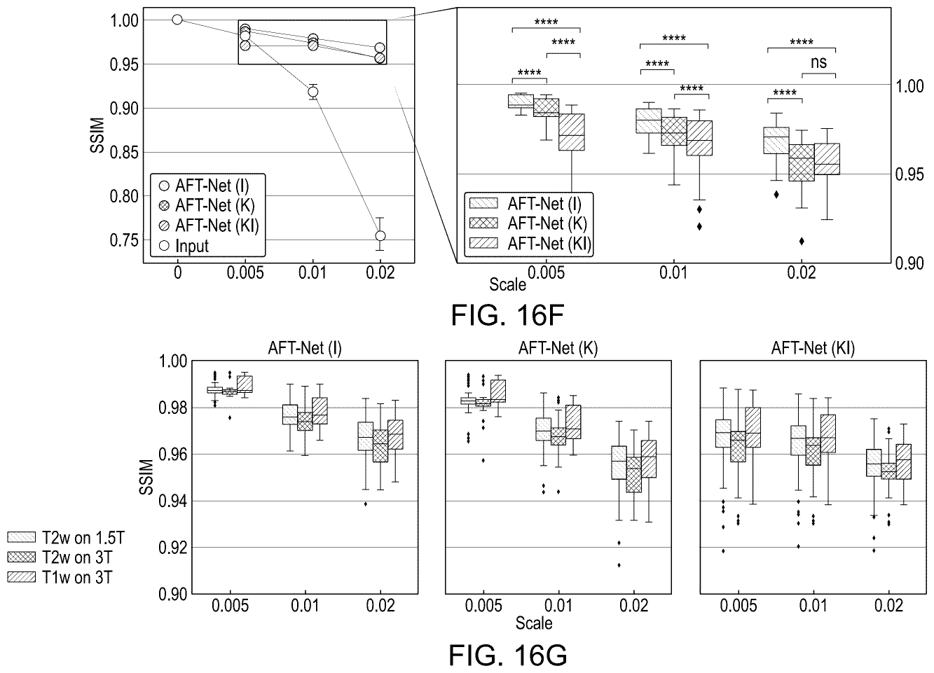

Consider first the human normal-field experiments for Study 2. The results of human 1.5/3T MRI reconstruction using raw fully-sampled fastMRI k-space data are shown in the image set of FIG. 16A. The ground truth image was derived by applying conventional Fourier transformation to the k-space data. It can be seen that the ground truth image obtained from FT is nearly identical to the AFT prediction, which human observers cannot distinguish. The residual map (pixel-wise difference between the ground truth image and the AFT prediction) in FIG. 16A shows that no brain structural information is presented. The grid-like remaining error is mainly caused by precision loss during floating-point calculation in matrix multiplication.

FIG. 16B shows the results of human 1.5/3T accelerated reconstruction using under-sampled fastMRI k-space data. The first row provides the reconstructions from 1D 4× equal-spaced sampling, in which 8% of low-frequency columns are retained. The reconstruction images provide a comparison of different AFT-Net structures with the zero-filling method. AFT-Net (KI) performs outstanding reconstruction, where less structural difference can be seen from the residual maps in the second row. The third row shows zoomed-in areas of both images and residual maps. AFT-Net (I) produces a more blurry reconstruction which loses the structural details. Reconstruction through AFT-Net (K) induces foggy artifacts, which is reflected in terms of SSIM.

FIG. 16C shows the accelerated reconstruction results by comparing AFT-Net (I, K, and KI) and zero filling in terms of SSIM across acceleration rates 2×, 4×, 8×, and 16×. The performance of zero filling drops linearly as the acceleration rate increases while the AFT-Net methods are more robust to the acceleration scale. The t-test between each AFT-Net structure indicates that the AFT-Net (KI) outperforms all other AFT-Net structures. The results of AFT-Net on different acquisition types and system field strength shown in FIG. 16D (providing results of human 1.5/3T MRI accelerated reconstruction by comparing AFT-Net in terms of SSIM on different acquisition types and system field strength for acceleration rates 2×, 4×, 8×, and 16×) demonstrate that AFT-Net is robust to contrast difference and image quality.

Next, the results of human 1.5/3T denoised reconstruction using fastMRI k-space data with added Gaussian noise are considered with reference to FIG. 16E. Unlike the results of accelerated reconstruction, AFT-Net (I) performs the best across all three proposed AFT-Net structures, which can be proved from the t-test results in FIG. 16F (showing results of human 1.5/3T MRI denoised reconstruction by comparing AFT-Net (K Model, I Model, and KI Model) and input in terms of SSIM for noise scales 0.005, 0.01 and 0.02). FIG. 16F also shows that AFT-Net (KI) shows comparable performance against AFT-Net (K) when the noise scale is 0.02 and underperforms other AFT-Net structures in noise scale 0.005 and 0.01, indicating that increasing the depth of AFT-Net does not necessarily increase the overall performance especially for denoised reconstruction task. The second row of FIG. 16E shows the pixel-wise difference between AFT-Net output and noiseless ground truth. It can be seen that the noise in the background is attenuated significantly. Although the brain structure can be seen from the residual map, the zoomed-in version of the image shows that the AFT-Net reconstruction preserves the anatomy structure. The results of AFT-Net on different acquisition types and system field strength in FIG. 16G (providing the results of human 1.5/3T MRI denoised reconstruction by comparing AFT-Net (I Model, K Model, and KI Model) in terms of SSIM on different acquisition types and system field strength for noise scales 0.005, 0.01, and 0.02) also demonstrate the generality of AFT-Net against different imaging modalities.

The results illustrated in FIGS. 16A-G show that AFT-Net (KI) significantly outperforms other AFT-Net structures on all the different acceleration rates. On all the different noise scales, AFT-Net (I) performs significantly better than other AFT-Net structures. It is worth mentioning that although AFT-Net (K) does not outperform other AFT-Net structures in both accelerated reconstruction and denoised reconstruction tasks, it demonstrates the ability to learn in a sparse frequency domain and its sparse representations with a complex-valued convolutional network.

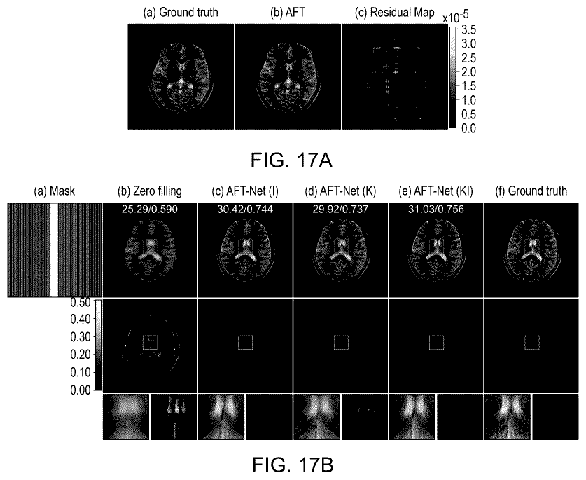

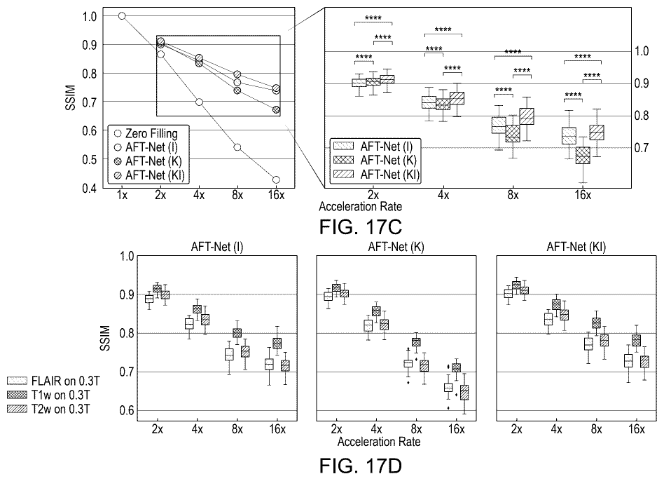

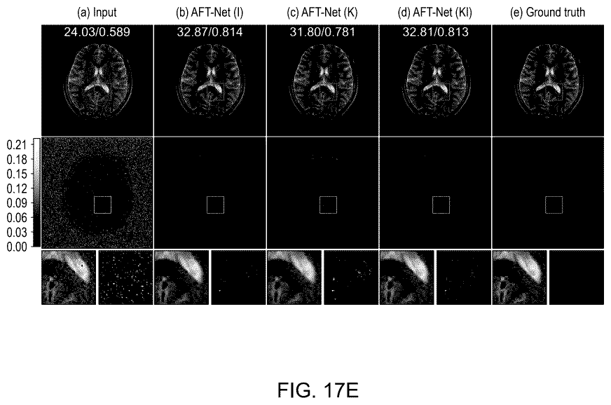

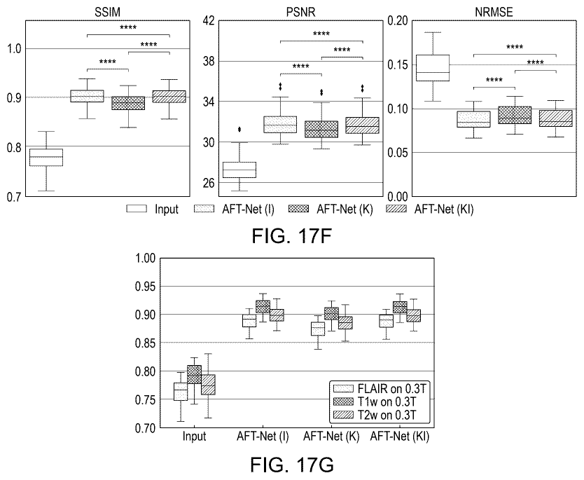

Next, consider the human low-field MRI experiments for Study 2. The results of human 0.3T MRI reconstruction results are shown in FIG. 17A. All images were processed at the size of 256×256, with phase encoding in the X (LR) direction, and no cropping or reshaping was done due to it having been done already by the original M4Raw authors. The ground truth image was derived from the raw k-space data using a conventional Fourier transform method. From the image, it can be seen we note that the image generated by AFT-Net is nearly identical to the Ground Truth. The residual map shows minor brain structural information around the edges of the brain. Most of the remaining grid error is from floating point errors during matrix multiplication.

In FIG. 17B, the results of human 0.3T accelerated reconstruction, using under-sampled M4Raw k-space data, are shown. The first row illustrates the reconstructions from 1D 4× equal-spaced sampling, in which 8% of low-frequency columns are retained. Different AFT-Net structures are compared against the Zero-Filling method. AFT-Net (KI) performs the best reconstruction, where the least structural difference can be seen from the residual map in the second row. The third row of FIG. 17B shows zoomed-in areas of both images and residual maps. AFT-Net (K) produces a blurrier reconstruction which loses the structural details. Reconstruction through AFT-Net (I) produces somewhat similar results to AFT-Net (KI) but loses some structural detail.

FIG. 17C shows the accelerated reconstruction results by comparing AFT-Net (I, K and KI) and zero filling in terms of SSIM across acceleration rates 2×, 4×, 8× and 16×. The performance of zero filling drops linearly as the acceleration rate increases while the AFT-Net methods are more robust to the acceleration scale. The t-test between each AFT-Net structure indicates that the AFT-Net (KI) clearly performs better than all other AFT-Net structures. The results of AFT-Net on different acquisition types and system field strength in FIG. 17D (providing results of human 0.3T MRI accelerated reconstruction by comparing AFT-Net (I Model, K Model, and KI Model) in terms of SSIM on different acquisition types and system field strength for acceleration rates 2×, 4×, 8×, and 16×) demonstrate that AFT-Net performs better on T1w images at 0.3T, but is robust in terms of image quality and retains excellent performance on other contrasts.

Next, the results of human 0.3T denoised reconstruction using M4Raw k-space data with added Gaussian noise are shown in FIG. 17E at a scale of 4.8. The noise scale was determined using the averaged maximum values of the dataset to stay in line with noise scales used for 1.5/3T tests. Unlike the results of accelerated reconstruction, AFT-Net (I) performs slightly better among three proposed AFT-Net structures, which can be seen in the t-test results of FIG. 17F (providing the results of human 0.3T MRI denoised reconstruction by comparing AFT-Net (I Model, K Model, and KI Model) in terms of SSIM, PSNR and NRMSE). It is noted that AFT-Net (I) does not hold a very significant advantage in SSIM, PSNR, or NRMSE compared to AFT-Net (KI). The second row of FIG. 17E shows the pixel-wise difference between AFT-Net output and noiseless ground truth. It can be seen that the noise in the background is attenuated significantly. Although the brain structure can be seen from the residual map, the zoomed-in version of the image shows that the AFT-Net reconstruction preserves the anatomical structure.

The results of AFT-Net on different acquisition types and system field strength in FIG. 17G (providing results of human 0.3T MRI denoised reconstruction by comparing AFT-Net (I Model, K Model, and KI Model) in terms of SSIM) demonstrate that AFT-Net performs better on T1w images at 0.3T, but has good generality against different imaging modalities.

Results of the human low-field MRI experiments of Study 2 show that AFT-Net (KI) significantly outperforms other AFT-Net structures on all the different acceleration rates. On denoised reconstruction, AFT-Net (I) performs slightly better than other AFT-Net structures. The experiment results show that although AFT-Net (K) does not outperform other AFT-Net structures in both accelerated reconstruction and denoised reconstruction tasks, it demonstrates the ability to learn in a sparse frequency domain and its sparse representations with a complex-valued convolutional network.

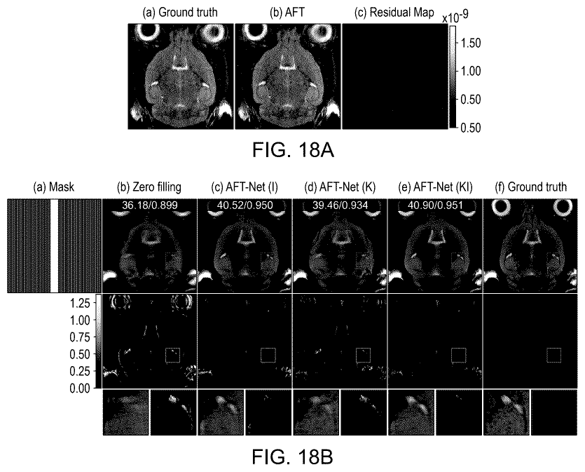

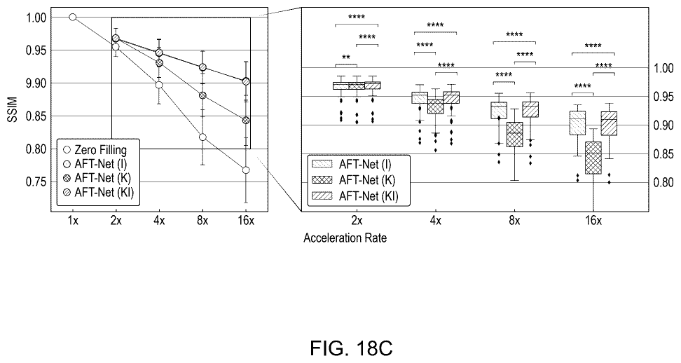

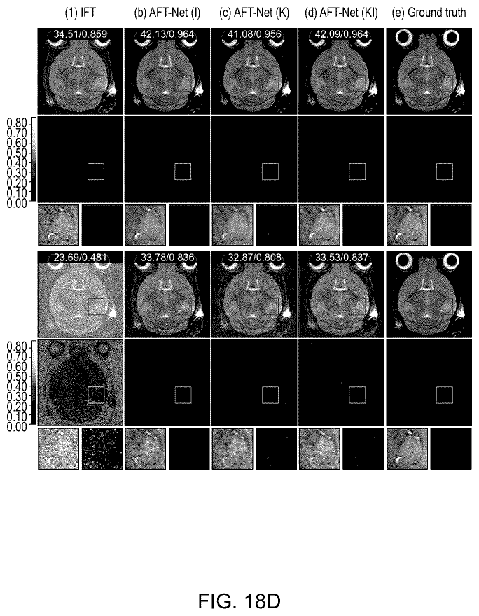

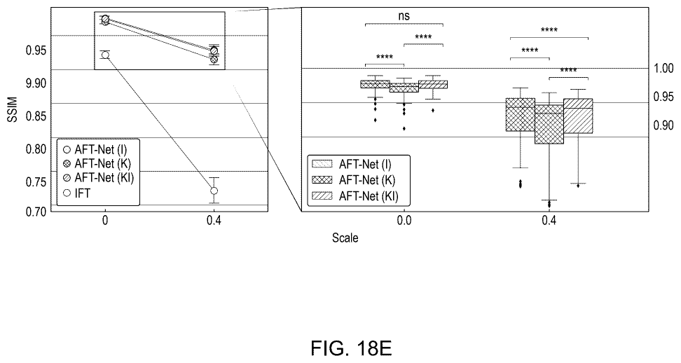

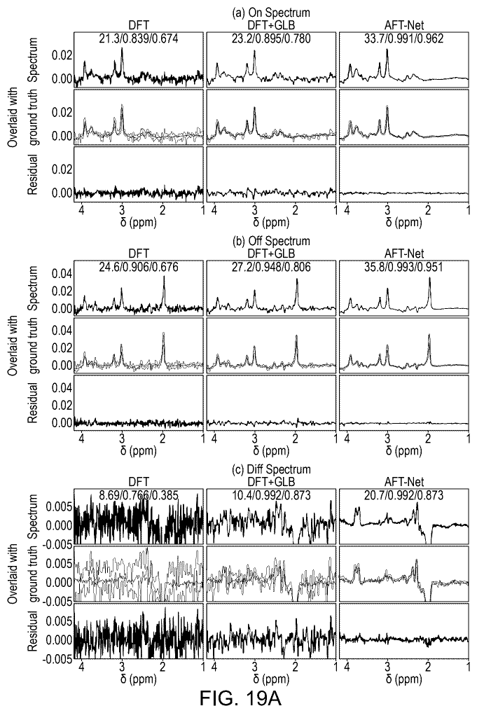

Next, the mouse high-field MRI study results were considered. FIG. 18A includes a set of reconstructed images showing the results of mouse 9.4T MRI reconstruction using fully-sampled k-space data acquired with a Bruker Biospec 94/30 scanner. The scanner is equipped with state-of-the-art MRI imaging RF coils, including a 1H mouse-head-only Cryogenic RF coil designed for boosted signal sensitivity with a proven factor at \tilde{3} for in vivo brain imaging. The reconstructed images were cropped so that the anti-aliasing placed outside the field of view (FOV) in phase-encoding directions is removed. The residual map (pixel-wise difference between the ground truth image and the AFT prediction) showed that no brain structural information is presented. The grid-like remaining error is mainly caused by precision loss during floating-point calculation in matrix multiplication.

FIG. 18B shows the results of mouse 9.4T accelerated reconstruction using under-sampled mouse MRI k-space data. The first row of FIG. 18B shows the reconstructions from 1D 4× equal-spaced sampling, in which 8% of low-frequency columns are retained. Different AFT-Net structures were compared against the Zero-Filling method. AFT-Net (KI) performs the best reconstruction, where the least structural difference can be seen from the residual map in the second row. The third row of FIG. 18B shows zoomed-in areas of both images and residual maps. AFT-Net (K) produces a blurrier reconstruction which loses the structural details. Reconstruction through AFT-Net (I) produces somewhat similar results to AFT-Net (KI) but loses some structural detail.

FIG. 18C shows the accelerated reconstruction results by comparing AFT-Net (I, K, and KI) and zero filling in terms of SSIM across acceleration rates 2×, 4×, 8×, and 16×. The performance of zero filling drops linearly as the acceleration rate increases while the AFT-Net methods are more robust to the acceleration scale. The t-test between each AFT-Net structure indicates that the AFT-Net (KI) performs better than all other AFT-Net structures. Next, FIG. 18D illustrates the results of mouse 9.4T denoised reconstruction using mouse MRI k-space data with added Gaussian noise at a scale of 0.8. Unlike the results of accelerated reconstruction, AFT-Net (I) performs slightly better among three proposed AFT-Net structures, which can be seen in the t-test results in FIG. 18E (showing results of mouse 9.4T MRI denoised reconstruction by comparing AFT-Net (I Model, K Model, and KI Model) in terms of SSIM, PSNR, and NRMSE).

Note that AFT-Net (I) does not hold a very significant advantage in SSIM, PSNR, or NRMSE compared to AFT-Net (KI). The second row of FIG. 18D shows the pixel-wise difference between AFT-Net output and noiseless ground truth. It can be seen that the noise in the background is attenuated significantly. Although the brain structure can be seen from the residual map, the zoomed-in version of the image shows that the AFT-Net reconstruction preserves the anatomical structure. The results of this part of Study 2 show that AFT-Net (KI) significantly outperforms other AFT-Net structures on all the different acceleration rates. On denoised reconstruction, AFT-Net (I) performs slightly better than other AFT-Net structures.

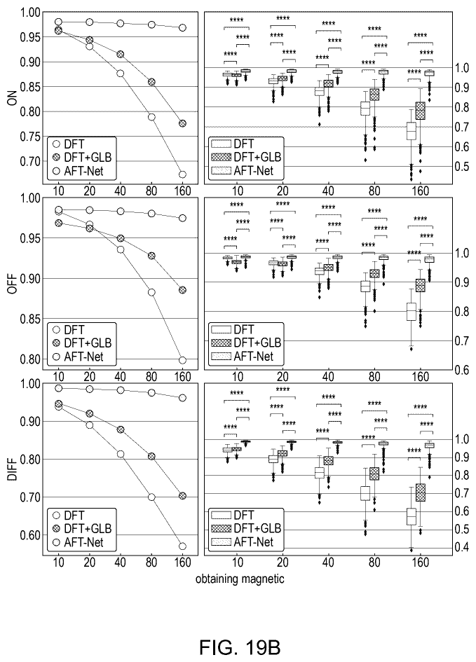

Lastly, the human normal-field MRS experiments were considered. Magnetic resonance spectroscopy, namely MRS, is widely used for measuring human metabolism. While MRS has the potential to be highly valuable in clinical practice, it poses several challenges such as low signal-to-noise ratio, overlapping metabolite signals, experimental artifacts, and long acquisition times. Here, the AFT-Net is leveraged as a unified MRS reconstruction approach, which aims to reconstruct and process the FID in parallel, as shown in FIG. 19A. FIG. 19A provides human 3T MRS denoised reconstruction results, in which the acceleration rate is 80 for each spectrum. The results include (a) reconstruction results for the ON spectrum, (b) reconstruction results for the OFF spectrum, and (c) results for the DIFF spectrum derived from (a) and (b). Additionally, the first row includes reconstructed spectra, the second row includes reconstructed spectra overlaid with ground truth, and the third row includes the difference of reconstructed spectra against ground truth. The numbers in the upper center location correspond to R (db), PCC, and SCC, respectively.

The model was trained on the MEGA-PRESS spectra from the Big GABA dataset for two reasons. First, as a proof of concept study, to guarantee the convergence of the supervised learning task, the dataset is needed to be sufficient in the number of samples, good in data quality, and publicly available. The Big GABA dataset meets these requirements. Second, the smaller targeted signals are revealed by the subtraction of 2 spectra containing strong signals (OFF and ON), which provide a good way to verify the performance of the proposed method by measuring the subtraction artifacts.

A total number of 101 subjects acquired by the Philips scanners were used in the training. For each subject, a standard GABA ON/OFF edited MRS acquisition was run, where ON editing pulses were placed at 1.9 ppm and OFF editing pulses were placed at 7.46 ppm. The acquisition number was 320 (160 ON and 160 OFF transients) per subject. The AFT-Net was trained with an input size of 2048. The ground truth of the ON/OFF spectra was derived by taking the average over 160 acquisitions. The ground truth was denoted as noiseless signals. For the training, randomly sampled acquisitions of each subject were combined to retrieve a noisy signal. By decreasing/increasing the number of sampled acquisitions, signals with higher/lower noise were generated. The reduction rate (R) was used to denote the level of noise, which is defined as the ratio of the total acquisition number and the number of acquisitions sampled. This quantity is very handy to assess the power of denoising methods in practical terms. Retrieving accurate denoised signals at a high R has implications for the potential reduction of total experimental time.

The results of the AFT-Net approach and conventional numerical methods with Gaussian line broadening are illustrated in FIG. 19B. The first row shows the reconstructed spectrum from the numerical methods and the proposed AFT-Net. The second row indicates the reconstructed spectrum overlaid with the ground truth. The third row plots the difference between the reconstructed spectrum and the ground truth. Under a reduction rate of 80, where only 2 acquisitions were used over all 160 acquisitions, the AFT-Net shows excellent performance at high reduction rates. The AFT-Net outperforms other methods for the DIFF spectra, indicating that the AFT-Net removes the noise in the FIDs while preserving the subject-level features. The Goodness-of-Fit Coefficient (GFC) was used to measure the similarity between the reconstructed spectra and the ground truth. The metric value increases as the reduction rate decreases, but the absolute difference between high and low reduction rates is tiny (0.9798 for OFF spectra under a reduction rate of 10 vs. 0.9688 for OFF spectra under a reduction rate of 160). In addition, AFT-Net outperforms the DFT+GLB (Gaussian Line Broadening) method across all metrics in the table.

The Study 2 experiments investigated a unified MR image reconstruction framework composed of two main components: artificial Fourier transform block and complex-valued residual attention U-Net. The AFT block is used to approximate the conventional DFT. The front-end/back-end convolutional layers are used to extract higher features in the k-space/image domains and play different roles in various tasks. As was shown in the discussion of the experiments, both front-end and back-end convolutional layers showed superior accelerated reconstruction performance under all sampling ratios compared with single front-end/back-end convolutional layers. This is potentially because the undersampling is performed in k-space where the artifacts are separated from the non-artifact. While in the image domain, it is converted to aliasing overlapped over the whole image. The artifacts removal task can be recast as an image inpainting problem in the k-space domain which can be done more easily by the front-end convolutional layers. The superiority of front-end convolutional layers does not always hold for all tasks, where back-end only convolutional layers outperform the front-end and back-end convolutional layers on the denoised reconstruction task. Although the linearity of the Fourier transform and the property that the Fourier transform of Gaussian noise is still Gaussian noise guarantee the possible workaround of denoising in both k-space and image domain, the sparse representation of k-space data makes it harder for a convolutional network to extract noise information in the low-frequency areas. Therefore, for the Study 2 experiments, all the structures with front-end convolutional layers showed lower performance, indicating that k-space noise removal with a convolutional network may not be a preferable approach.

In some embodiments, AFT-Net can be applied to 1D data. He AFT-Net framework can also determine the loss in the complex-valued image domain, which preserves the relations between the real and imaginary parts. The phase is then derived from the output of AFT-Net, which is essential for several phase-based applications.

The proposed framework described herein was also investigated for the different impacts of complex-valued convolutional networks on the k-space and image domain, and the extension to accelerated reconstruction and denoised reconstruction, which are more clinically important. Domain-manifold learning was incorporated by adding domain transform blocks which determine the mapping between the k-space and image domain instead of conventional discrete Fourier transform. The proposed approach is more robust to noise and signal nonideality due to imperfect acquisition.

The application of complex-valued convolutional networks was further extended to 1D MRS denoised reconstruction. One potential methodological limitation is that the FC layers used by AFT-Net narrow the application to datasets with various image matrix sizes. Although the convolutional layers are not sensitive to the image matrix sizes and cropping/padding can be applied to match the desired sizes, the features of FC layers need to be selected carefully. Another parameter that needs to be taken into account is the coil number. The proposed framework may be modified to incorporate diffusion models, which are powerful tools for image reconstruction across body regions and coil numbers. In various embodiments, the AFT-Net framework could be further extended by leveraging diffusion-based models with complex-valued convolutional networks as the backbone and careful optimization to reduce the inference time.

Performing the various techniques and operations described herein may be facilitated by a controller device (e.g., a processor-based computing device). Such a controller device may include a processor-based device such as a computing device, and so forth, that typically includes a central processor unit (CPU) or a processing core. The device may also include one or more dedicated learning machines (e.g., neural networks) that may be part of the CPU processing core. In addition to the CPU or processing core, the system includes main memory, cache memory and bus interface circuits. The controller device may include a memory storage device, such as a hard drive (solid state hard drive, or other types of hard drive), or flash drive associated with the computer system. The controller device may further include a keyboard, or keypad, or some other user input interface, and a monitor, e.g., an LCD (liquid crystal display) monitor, that may be placed where a user can access them.

The controller device is configured to facilitate, for example, image reconstruction from MR k-space data. The storage device of the controller device may thus include a computer program product that when executed on the controller device (which, as noted, may be a processor-based device) causes the processor-based device to perform operations to facilitate the implementation of procedures and operations described herein. The controller device may further include peripheral devices to enable input/output functionality. Such peripheral devices may include, for example, flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, a graphics processing unit (GPU), application processing unit (APU), etc., may be used in the implementations of the controller device. Other modules that may be included with the controller device may include a user interface to provide or receive input and output data. The controller device may include an operating system.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A computer-implemented method for reconstructing images, comprising:
obtaining magnetic resonance (MR) k-space data resulting from a scan performed by an MRI scanner on tissue of a patient, the MR k-space data including complex-valued data; and
processing, by a complex-valued machine learning image reconstruction system, the complex-valued data of the MR k-space data to generate image data representing features of the MR k-space data.

2. The method of claim 1, wherein processing by the complex-valued machine learning image reconstruction system comprises:
estimating the image data with a machine learning inverse Fourier transform engine, implementing an inverse Fourier transform model, applied to input data based on the k-space data.

3. The method of claim 2, wherein estimating the image data comprises:
estimating the image data with the machine learning inverse Fourier transform engine applied to the k-space data.

4. The method of claim 2, processing by the complex-valued machine learning image reconstruction system further comprises
performing data filtering operations, by one or more machine learning filter blocks implemented according to a CU-Net architecture realized using one or more convolutional neural networks (CNN) configured for complex data processing, on data that is based on the k-space data.

5. The method of claim 4, wherein performing the data filtering operations comprises:
performing, by a CU-Net filter block, from the one or more machine learning filter blocks, positioned upstream of the machine learning inverse Fourier transform engine, one or more of data segmentation processing and/or de-noising processing on the k-space data.

6. The method of claim 4, wherein performing the data filtering operations comprises:
performing de-noising filtering operations, by a de-noising CU-Net filter block positioned downstream of the machine learning inverse Fourier transform engine, on the estimated image data produced by the machine learning inverse Fourier transform engine.

7. The method of claim 4, wherein performing the data filtering operations comprises:
performing one or more of segmentation processing operations and/or de-noising processing on the k-space data by a first U-Net filter block, positioned upstream of the inverse Fourier transform engine; and
performing one or more of segmenting operation and/or de-noising operations on the estimated image data, produced by the machine learning inverse Fourier transform engine in response to receiving the processed k-space data, by a second CU-Net filter block positioned downstream of the machine learning inverse Fourier transform engine.

8. The method of claim 1, further comprising:
training the complex-valued machine learning image reconstruction system to generate estimated image data representing features of the MR k-space data based on samples of k-space data and corresponding image data representing ground truth for the complex-valued machine learning image reconstruction system.

9. The method of claim 8, wherein the complex-valued machine learning image reconstruction system is trained to produce high-quality images from low-quality MR k-space data.

10. The method of claim 8, wherein training the complex-valued machine learning image reconstruction system comprises:
performing intermittent updated training for the complex-valued machine learning image reconstruction engine, including:
performing a transform on at least part of an MR k-space training dataset to produce a transform output; and
evaluating a loss function to produce an error evaluation based at least in part on the estimated image data generated by the complex-values machine learning image reconstruction system and the transform output.

11. The method of claim 10, further comprising:
adjusting parameters of the complex-valued machine learning image reconstruction engine based on the error evaluation produced by the loss function.

12. The method of claim 10, wherein performing the transform comprises performing an inverse fast Fourier transform on at least part of the MR k-space training dataset.

13. The method of claim 8, wherein the complex-valued machine learning image reconstruction engine is further trained to produce denoised high-quality images.

14. A system for reconstructing MRI images, comprising:
one or more computer-readable hardware storage devices to store and executable program code; and
a processor-based device, in electrical communication with the one or more computer-readable hardware storage devices, the processor-based device configured to:
obtain magnetic resonance (MR) k-space data resulting from a scan performed by an MRI scanner on tissue of a patient, the MR k-space data including complex-valued data; and
process, by a complex-valued machine learning image reconstruction system, the complex-valued data of the MR k-space data to generate image data representing features of the MR k-space data.

15. The system of claim 14, wherein the processor-based device configured to process the complex-valued data is configured to:
estimate the image data with a machine learning inverse Fourier transform engine, implementing an inverse Fourier transform model, applied to input data based on the k-space data.

16. The system of claim 15, wherein the processor configured to estimate the image data is configured to:
estimate the image data with the machine learning inverse Fourier transform engine applied to the k-space data.

17. The system of claim 15, wherein the processor configured to process is further configured to:
perform data filtering operations, by one or more machine learning filter blocks implemented according to a CU-Net architecture realized using one or more convolutional neural networks (CNN) configured for complex data processing, on data that is based on the k-space data.

18. The system of claim 17, wherein the processor configured to perform the data filtering operations is configured to:
perform, by a CU-Net filter block, from the one or more machine learning filter blocks, positioned upstream of the machine learning inverse Fourier transform engine, one or more of data segmentation processing and/or de-noising processing on the k-space data.

19. The system of claim 17, wherein the processor configured to perform the data filtering operations is configured to:
perform de-noising filtering operations, by a de-noising CU-Net filter block positioned downstream of the machine learning inverse Fourier transform engine, on the estimated image data produced by the machine learning inverse Fourier transform engine.

20. Non-transitory computer readable media comprising computer instructions executable on a processor-based device to:
obtain magnetic resonance (MR) k-space data resulting from a scan performed by an MRI scanner on tissue of a patient, the MR k-space data including complex-valued data; and
process, by a complex-valued machine learning image reconstruction system, the complex-valued data of the MR k-space data to generate image data representing features of the MR k-space data.
